(19) United States
(12) Patent Application Publication
(10) Pub. No.: US 2021/0390396 A1
(43) Pub. Date: Dec. 16, 2021

(54) Systems and Methods for Generative Models for Design

(71) Applicant: The Board of Trustees of the Leland Stanford Junior University, Stanford, CA (US)

(72) Inventors: Jonathan Albert Fan, Palo Alto, CA (US); Jiaqi Jiang, Stanford, CA (US)

(73) Assignee: The Board of Trustees of the Leland Stanford Junior University, Stanford, CA (US)

(21) Appl. No.: 17/259,130

(22) PCT Filed: Jul. 11, 2019
(86) PCT No.: PCT/US2019/041414

§ 371 Date: Jan. 8, 2021

Related U.S. Application Data
(60) Provisional application No. 62/843,186, filed on May 3, 2019.
(60) Provisional application No. 62/772,570, filed on Nov. 28, 2018.
(60) Provisional application No. 62/696,700, filed on Jul. 11, 2018.

(51) Int. Cl. G06N 3/08; G06N 3/04; G06F 30/27

(52) U.S. Cl. CPC G06N 3/08; G06F 2119/02; G06F 30/27; G06N 3/0454

(57) ABSTRACT

Systems and methods for generating designs in accordance with embodiments of the invention are illustrated. One embodiment includes a method for training a generator to generate designs. The method includes steps for generating a plurality of candidate designs using a generator, evaluating a performance of each candidate design of the plurality of candidate designs, computing a global loss for the plurality of candidate designs based on the evaluated performances, and updating the generator based on the computed global loss.

### CROSS-REFERENCE TO RELATED APPLICATIONS

The current application is a U.S. national phase of PCT Application No. PCT/US2019/041414 entitled, “Systems and Methods for Generative Models for Design”, filed Jul. 11, 2019, which claims the benefit of and priority under 35 U.S.C. § 119(e) to U.S. Provisional Patent Application No. 62/696,700 entitled “Metamaterial Discovery Based on Generative Neural Networks” filed Jul. 11, 2018, U.S. Provisional Patent Application No. 62/772,570 entitled “Systems and Methods for Data-Driven Metasurface Discovery” filed Nov. 28, 2018, and U.S. Provisional Patent Application No. 62/843,186 entitled “Global Optimization of Dielectric Metasurfaces Using a Physics-driven Neural Network” filed May 3, 2019. The disclosures of PCT Application No. PCT/US2019/041414 and U.S. Provisional Patent Application Nos. 62/696,700, 62/772,570, and 62/843,186 are hereby incorporated by reference in their entirety for all purposes.

This work was supported by the U.S. Air Force under Award Number FA9550-18-1-0070, the Office of Naval Research under Award Number N00014-16-1-2630.

### FIELD OF THE INVENTION

The present invention generally relates to design optimization and, more specifically, to training generative models for optimizing designs.

### BACKGROUND

Metasurfaces are subwavelength-structured artificial media that can shape and localize electromagnetic waves in unique ways. Photonic technologies serve to manipulate, guide, and filter electromagnetic waves propagating in free space and in waveguides. Due to the strong dependence between geometry and function, much emphasis in the field has been placed in identifying geometric designs for these devices given a desired optical response. The vast majority of these design concepts utilize relatively simple shapes that can be described using physical intuition.

As examples, silicon photonic devices typically utilize adiabatic tapers and ring resonators to route and filter guided waves, and metasurfaces, which are diffractive optical components used for wavefront engineering, typically utilize arrays of nanowaveguides or nanoresonators comprising simple shapes. While these design concepts work well for certain applications, they possess limitations, such as narrow bandwidths and sensitivity to temperature, which prevents the further advancement of these technologies.

### SUMMARY OF THE INVENTION

Systems and methods for generating designs in accordance with embodiments of the invention are illustrated. One embodiment includes a method for training a generator to generate designs. The method includes steps for generating a plurality of candidate designs using a generator, evaluating a performance of each candidate design of the plurality of candidate designs, computing a global loss for the plurality of candidate designs based on the evaluated performances, and updating the generator based on the computed global loss.

In a further embodiment, the method further includes steps for receiving an input element of features representing the plurality of candidate designs, wherein the input element includes a random noise vector.

In still another embodiment, the input element further includes a set of one or more target parameters, and the set of target parameters includes at least one of a wavelength, a deflection angle, device thickness, device dielectric, polarization, phase response, and incidence angle.

In a still further embodiment, evaluating the performance includes performing a simulation of each candidate design.

In yet another embodiment, the simulation is performed using a physics-based engine.

In a yet further embodiment, computing the global loss includes weighting a gradient for each candidate design based on a value of a performance metric for the candidate design.

In another additional embodiment, the performance metric is efficiency.

In a further additional embodiment, computing the global loss comprises computing forward electromagnetic simulations of the plurality of candidate designs, computing adjoint electromagnetic simulations of the plurality of candidate designs, and computing an efficiency gradient with respect to refractive indices for each candidate design by integrating the overlap of the forward electromagnetic simulations and the adjoint electromagnetic simulations.

In another embodiment again, the global loss includes a regularization term to ensure binarization of the generated patterns.

In a further embodiment again, the generator includes a set of one or more differentiable filter layers.

In still yet another embodiment, the filter layers includes at least one of a Gaussian filter layer and a set of one or more binarization layers to ensure binarization of the generated patterns.

In a still yet further embodiment, the method further includes steps for receiving a second input element that represents a second plurality of candidate designs, generating the second plurality of candidate designs using the generator, wherein the generator is trained to generate high-efficiency designs, evaluating each candidate design of the second plurality of candidate designs based on simulated performance of each of the second plurality of candidate designs, and selecting a set of one or more highest-performing candidate designs from the second plurality of candidate designs based on the evaluation.

In still another additional embodiment, each design of the plurality of candidate designs is a metasurface.

One embodiment includes a non-transitory machine readable medium containing processor instructions for training a generator to generate designs, where execution of the instructions by a processor causes the processor to perform a process that generates a plurality of candidate designs using a generator, evaluates a performance of each candidate design of the plurality of candidate designs, computes a global loss for the plurality of candidate designs based on the evaluated performances, and updates the generator based on the computed global loss.

One embodiment includes a system comprising a processor and a memory, wherein the memory comprises a training application for training a generator to generate designs, where execution of the instructions by a processor causes the processor to perform a process that generates a plurality of candidate designs using a generator, evaluates a performance of each candidate design of the plurality of candidate designs, computes a global loss for the plurality of candidate designs based on the evaluated performances, and updates the generator based on the computed global loss.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a system that can be used for metasurface design in accordance with various embodiments of the invention.

FIG. 2 illustrates an example of a generation element for training and utilizing a generative model in accordance with a number of embodiments of the invention.

FIG. 3 illustrates a system for training a model to generate candidate device designs in accordance with an embodiment of the invention.

FIG. 4 conceptually illustrates a process for training a model to generate candidate device designs in accordance with an embodiment of the invention.

FIG. 5 illustrates examples of high-resolution images of topology-optimized metagratings in accordance with an embodiment of the invention.

FIG. 6 illustrates representative images from a training dataset in accordance with many embodiments of the invention.

FIG. 7 illustrates an example of a conditional GAN in accordance with an embodiment of the invention.

FIG. 8 illustrates device efficiency distributions for sample devices generated in accordance with an embodiment of the invention.

FIG. 9 illustrates efficiencies of eroded, intermediate, and dilated device geometries over the course of topology optimization for devices in accordance with an embodiment of the invention.

FIG. 10 illustrates an example of a top view of a metagrating unit cell before and after topology refinement in accordance with an embodiment of the invention.

FIG. 11 illustrates representative images of high efficiency metagratings from a generator in accordance with an embodiment of the invention.

FIG. 12 illustrates device efficiency plots for metagratings produced by GAN generators in accordance with a number of embodiments of the invention.

FIG. 13 illustrates a comparison between device efficiency plots for generated metagratings and metagratings of a training dataset in accordance with an embodiment of the invention.

FIG. 14 illustrates benchmarking of GAN-based computation cost and network retraining efficacy in accordance with an embodiment of the invention.

FIG. 15 illustrates efficiency distributions of brute force topology-optimization and refined GAN-generated devices at various wavelengths and deflection angles in accordance with an embodiment of the invention.

FIG. 16 illustrates the overall design platform in accordance with an embodiment of the invention.

FIG. 17 illustrates a comparison between adjoint-based topology optimization and global optimization in accordance with an embodiment of the invention.

FIG. 18 illustrates an example schematic of a silicon metagrating that deflects normally-incident TM-polarized light of wavelength to an outgoing angle θ.

FIG. 19 illustrates a schematic of a generative neural network-based optimization in accordance with an embodiment of the invention.

FIG. 20 illustrates a schematic of a global optimization network for conditional metagrating generation in accordance with an embodiment of the invention.

FIG. 21 illustrates examples of filter layers in accordance with an embodiment of the invention.

FIG. 22 illustrates an example network architecture of a conditional global optimization network in accordance with an embodiment of the invention.

FIG. 23 conceptually illustrates a process for training a global optimization network in accordance with an embodiment of the invention.

FIG. 24 illustrates results of global optimization processes in accordance with a number of embodiments of the invention using a simple testing case.

FIG. 25 illustrates efficiencies for devices designed using brute-force optimization and processes in accordance with many embodiments of the invention.

FIG. 26 illustrates efficiency histograms, for select wavelength and angle pairs, of devices designed using brute-force topology optimization and generative neural network-based optimization.

FIG. 27 illustrates results from adjoint-based topology optimization and global optimization networks.

FIG. 28 illustrates efficiency histograms from adjoint-based topology optimization and global optimization, for select wavelength and angle pairs.

FIG. 29 illustrates results from a conditional global optimization network.

FIG. 30 illustrates a visualization of the evolution of device patterns and efficiency histograms as a function of global optimization training.

FIG. 31 illustrates a visualization of the evolution of device patterns and efficiency histograms as a function of conditional global optimization training.

FIG. 32 illustrates efficiency histograms of generated devices for unconditional global optimization at various iterations.

FIG. 33 illustrates efficiency histograms of generated devices for conditional global optimization at various iterations.

FIG. 34 illustrates example results of adjoint-based boundary optimization in accordance with a number of embodiments of the invention.

FIG. 35 illustrates an example of a meta-learning system in accordance with an embodiment of the invention.

### DETAILED DESCRIPTION

Turning now to the drawings, systems and methods for training and utilizing generative networks for global optimization (or optimization networks or generative design networks) in a design process. In a variety of embodiments, global optimization networks can be trained to generate multiple designs and to use a simulator (e.g., a physics based simulation) to determine various parameters of the designs. Parameters in accordance with various embodiments of the invention can be used for various purposes including (but not limited to) identifying high-performing designs, identifying adjoint gradients, computing a loss function, etc. In numerous embodiments, rather than training data, a simulator is used to perform forward and adjoint electromagnetic simulations to train a generative design network. In several embodiments, generative design networks can be trained using training data, as well as augmented training data that is generated using a generative design network. Augmented training data can include (but is not limited to) designs that are generated for parameter values outside the range of the values found in the training data, as well as high-performing designs discovered during the generation process. Generative design networks in accordance with numerous embodiments of the invention can be conditional networks, allowing for the specification of specific target parameters for the designs to be generated.

In numerous embodiments, processes can be used for generating and discovering metasurface designs in accordance with various embodiments of the invention are illustrated. Metasurfaces are subwavelength-structured artificial media that can shape and localize electromagnetic waves in unique ways. Metasurfaces are foundational devices for wavefront engineering because they have electromagnetic properties that are tailored by subwavelength-scale structuring. Metasurfaces can focus and steer an incident wave and manipulate its polarization in nearly arbitrary ways, surpassing the limits set by conventional optics. They can also shape and filter spectral features, which has practical applications in sensing. These technologies are useful in imaging, sensing, and optical information processing applications, amongst others, and can operate at wavelengths spanning the ultraviolet to radio frequencies. Metasurfaces have been implemented in frameworks as diverse as holography and transformation optics, and they can be used to perform mathematical operations with light.

Conventional metasurfaces utilize discrete phased array elements, such as plasmonic antennas, nanowaveguides, and Mie-resonant nanostructures. These devices produce high efficiency responses when designed for modest deflection angles and single functions. However, when designed for more advanced capabilities, they suffer from reduced efficiencies due to their restrictive design space. Iterative topology optimization, including adjoint-based and objective-first methods, is an alternative design approach that can extend the capabilities of metasurfaces beyond those utilizing phased array elements. Devices based on this concept have non-intuitive, freeform layouts, and they can support high efficiency, large angle, multi-wavelength operation. However, the design process is computationally intensive and requires many simulations per device, preventing its scaling to large aperiodic regions.

In many embodiments, generative networks for global optimization use conditional generative adversarial networks (GANs), which can serve as an effective and computationally efficient tool to produce high performance designs with advanced functionalities. As a model system, conditional GANs in accordance with a number of embodiments of the invention can generate silicon metagratings with various target characteristics (such as, but not limited to, deflection angle, wavelength, etc.), which are periodic metasurfaces designed to deflect electromagnetic waves to a desired diffraction order.

In several embodiments, conditional GANs can be trained on high-resolution images of high efficiency, topology-optimized devices. After training, conditional GANs in accordance with several embodiments of the invention can generate high performance metagratings operating across a broad range of wavelengths and angles. While many of the examples described herein focus on the variation of two device parameters (i.e., wavelength and deflection angle), one can imagine generalizing the generative design approach to other device parameters as well as different combinations of such parameters. Device parameters in accordance with several embodiments of the invention can include (but are not limited to) device thickness, device dielectric, polarization, phase response, and incidence angle. Compared to devices designed using only iterative optimization, processes in accordance with various embodiments of the invention can produce and refine devices at over an order of magnitude faster time scale. Optimization networks trained in accordance with a number of embodiments of the invention are capable of learning features in topologically complex metasurfaces, and can produce high performance, large area devices with tractable computational resources.

Many approaches based on feedforward neural networks attempt to explicitly learn the relationship between device geometry and electromagnetic response. In prior studies, neural networks were applied to the inverse design of relatively simple shapes, described by a small number of geometric parameters. These studies successfully demonstrated the potential of deep neural networks for electromagnetics design. However, they required tens of thousands of training data points and are limited to the design of simple geometries, making the scaling of these concepts to complicated shapes extremely data intensive.

With conditional GANs, which are deep generative models, processes in accordance with certain embodiments of the invention directly sample the space of high efficiency designs without the need to accurately predict the performance of every device along an optimization trajectory. This focused sampling focuses learning on important topological features harvested from high-performance metasurfaces, rather than attempting to predict the behavior of every possible device, most of which are very far from optimal. In this manner, optimization networks can produce high efficiency, topologically-intricate metasurfaces with substantially less training data.

Various methods based on local optimization have been proposed. Among the most successful of these concepts is the adjoint variables method, which uses gradient descent to iteratively adjust the dielectric composition of the devices and improve device functionality. This design method has enabled the realization of high performance, robust devices with nonintuitive layouts, including new classes of on-chip photonic devices with ultrasmall footprints, non-linear photonic switches, and diffractive optical components that can deflect and focus electromagnetic waves with high efficiencies. While adjoint optimization has great potential, it is a local optimizer and depends strongly on the initial distribution of dielectric material in the devices. As such, identifying a high performance device typically requires the optimization of many devices with random initial dielectric distributions and selecting the best device. This approach is very computationally expensive, preventing the scaling of these concepts to large, multi-functional devices.

Systems and methods in accordance with many embodiments of the invention present a new type of global optimization, based on the training of a generative neural network without a training set, which can produce high-performance metasurfaces. Instead of directly optimizing devices one at a time, optimization can be reframed as the training of a generator that iteratively enhances the probability of generating high-performance devices. In many embodiments, loss functions used for backpropagation can be defined as a function of generated patterns and their performance gradients. Performance gradients in accordance with numerous embodiments of the invention can include efficiency gradients which can be calculated by the adjoint variable method using physics based simulations, such as (but not limited to) forward and adjoint electromagnetic simulations. Performance gradients in accordance with a variety of embodiments of the invention can include (but are not limited to) heat conductivity in a thermal conductor used as a heat sink, generated power in a thermoelectric, speed and power in an integrated circuit, and/or power generated in a solar collection device.

Distributions of devices generated by the network continuously shift towards high-performance design space regions over the course of optimization. Upon training completion, the best-generated devices have efficiencies comparable to or exceeding the best devices designed using standard topology optimization. Similar processes in accordance with several embodiments of the invention can generally be applied to gradient-based optimization problems in various fields, such as (but not limited to) optics, mechanics and electronics. Systems and methods in accordance with a number of embodiments of the invention train and employ generative neural networks to produce high performance, topologically complex metasurfaces in a computationally efficient manner.

Systems and methods in accordance with many embodiments of the invention provide a global optimizer, based on a generative neural network, which can output highly efficient topology-optimized metasurfaces operating across a range of parameters. A key feature of the network in accordance with a number of embodiments of the invention is the presence of a noise vector at the network input, which enables the full design parameter space to be sampled by many device instances at once. In a variety of embodiments, training can be performed by calculating the forward and adjoint electromagnetic simulations of outputted devices and using the subsequent efficiency gradients for back propagation. With metagratings operating across a range of wavelengths and angles as a model system, devices produced from trained global optimization networks in accordance with certain embodiments of the invention can have efficiencies comparable to the best devices produced by brute force topology optimization. Reframing of adjoint-based optimization to the training of a generative neural network can apply generally to physical systems that support performance improvements by gradient descent.

Systems and methods in accordance with numerous embodiments of the invention introduce a new concept in electromagnetic device design by incorporating adjoint variable calculations directly into generative neural networks. Systems in accordance with some embodiments of the invention are capable of generating high performance topology-optimized devices spanning a range of operating parameters with modest computational cost. In numerous embodiments, a global search can be performed in the design space by sampling many device instances, which cumulatively span the design space, and optimize the responses of the device instances using physics-based calculations over the course of network training. As a model system, an ensemble of silicon metagratings can be designed that operate across a range of wavelengths and deflection angles. Although many of the examples described herein are specified for silicon metagratings, one skilled in the art will recognize that similar systems and methods can be used in a variety of applications, including (but not limited to) aperiodic, broadband devices, without departing from this invention.

### Systems for Generative Design

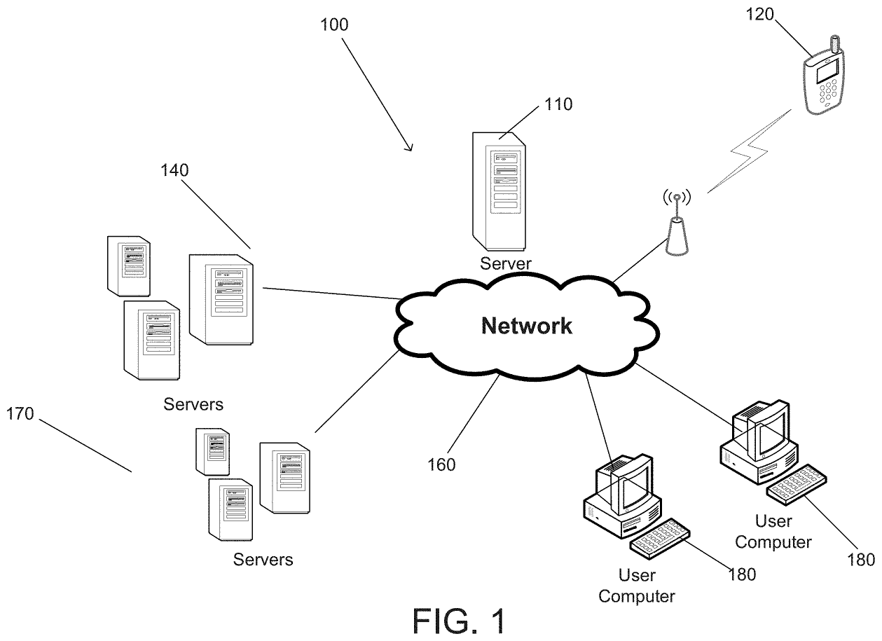

A system that can be used for generative design in accordance with some embodiments of the invention is shown in FIG. 1. Network 100 includes a communications network 160. The communications network 160 is a network such as the Internet that allows devices connected to the network 160 to communicate with other connected devices. Server systems 110, 140, and 170 are connected to the network 160. Each of the server systems 110, 140, and 170 is a group of one or more servers communicatively connected to one another via internal networks that execute processes that provide cloud services to users over the network 160. For purposes of this discussion, cloud services are one or more applications that are executed by one or more server systems to provide data and/or executable applications to devices over a network. The server systems 110, 140, and 170 are shown each having three servers in the internal network. However, the server systems 110, 140 and 170 may include any number of servers and any additional number of server systems may be connected to the network 160 to provide cloud services. In accordance with various embodiments of this invention, processes for training models and/or generating designs are provided by executing one or more processes on a single server system and/or a group of server systems communicating over network 160.

Users may use personal devices 180 and 120 that connect to the network 160 to perform processes for receiving, performing and/or interacting with a deep learning network that uses systems and methods for training models and/or generating designs in accordance with various embodiments of the invention. In the illustrated embodiment, the personal devices 180 are shown as desktop computers that are connected via a conventional “wired” connection to the network 160. However, the personal device 180 may be a desktop computer, a laptop computer, a smart television, an entertainment gaming console, or any other device that connects to the network 160 via a “wired” and/or “wireless” connection. The mobile device 120 connects to network 160 using a wireless connection. A wireless connection is a connection that uses Radio Frequency (RF) signals, Infrared signals, or any other form of wireless signaling to connect to the network 160. In FIG. 1, the mobile device 120 is a mobile telephone. However, mobile device 120 may be a mobile phone, Personal Digital Assistant (PDA), a tablet, a smartphone, or any other type of device that connects to network 160 via a wireless connection without departing from this invention. In accordance with some embodiments of the invention, the processes for training models and/or generating designs are performed by the user device.

Although a specific example of a system for generative design is illustrated in FIG. 1, any of a variety of systems can be utilized to perform processes similar to those described herein as appropriate to the requirements of specific applications in accordance with embodiments of the invention. One skilled in the art will recognize that a particular generative design system may include other components that are omitted for brevity without departing from this invention.

### Generative Design Element

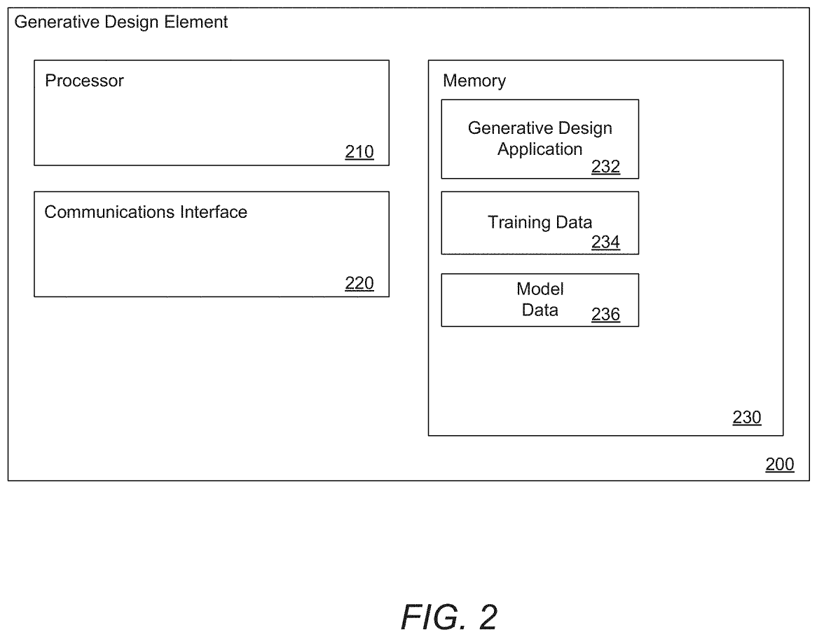

An example of a generative design element for training and/or utilizing a generative model in accordance with a number of embodiments is illustrated in FIG. 2. In various embodiments, generation design element 200 is one or more of a server system and/or personal devices within a networked system similar to the system described with reference to FIG. 1. Generative design element 200 includes a processor (or set of processors) 210, communications interface 220, peripherals 225, and memory 230. The communications interface 220 is capable of sending and receiving data across a network over a network connection. In a number of embodiments, the communications interface 220 is in communication with the memory 230.

Peripherals 225 can include any of a variety of components for capturing data, such as (but not limited to) cameras, displays, and/or sensors. In a variety of embodiments, peripherals can be used to gather inputs and/or provide outputs. Peripherals and/or communications interfaces in accordance with many embodiments of the invention can be used to gather inputs that can be used to train and/or design various generative elements.

In several embodiments, memory 230 is any form of storage configured to store a variety of data, including, but not limited to, a generative design application 232, training data 234, and model data 236. Generative design application 232 in accordance with some embodiments of the invention directs the processor 210 to perform any of a variety of processes, such as (but not limited to) using data from training data 234 to update model parameters 236 in order to train and utilize generative models to generate outputs. In a variety of embodiments, generative design applications can perform any of a number of different functions including (but not limited to) simulating performance of generated outputs, computing global losses, global optimization, and/or retraining generative models based on generated, simulated, and/or optimized outputs. In some embodiments, training data can include “true” data which a conditional generator is being trained to imitate. For example, true data can include examples of highly efficient metagrating designs, which can be used to train a generator to generate new samples of metagrating designs. Alternatively, or conjunctively, generative design models in accordance with many embodiments of the invention can be trained using no training data at all. Model data or parameters can include data for generator models, discriminator models, and/or other models that can be used in the generative design process.

Although a specific example of a generative design element is illustrated in FIG. 2, any of a variety of generative design elements can be utilized to perform processes similar to those described herein as appropriate to the requirements of specific applications in accordance with embodiments of the invention. One skilled in the art will recognize that a particular generative design system may include other components that are omitted for brevity without departing from this invention.

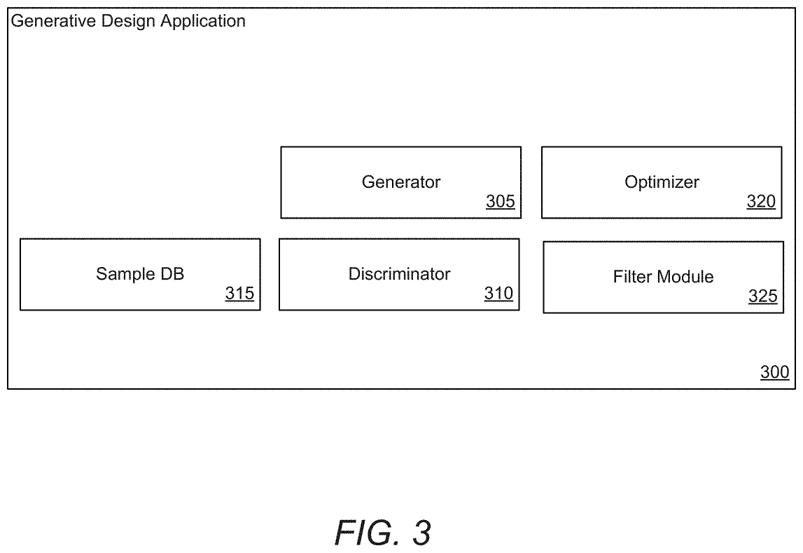

A generative design application for training a model for generative design in accordance with an embodiment of the invention is conceptually illustrated in FIG. 3. Generative design application 300 includes generator 305, discriminator 310, sample database 315, optimizer 320, and filter module 325. Generative design applications in accordance with a variety of embodiments of the invention can be performed on a single processor, a number of processors on a single machine, or may be distributed across multiple processors across multiple machines. In this example, generator 305 is trained adversarially with discriminator 310. Discriminator 310 is trained to discriminate between samples pulled from sample database 315 and samples generated by generator 305. As discriminator 310 gets better at distinguishing generated samples, the error is propagated back to generator 305, which learns to generate more realistic samples, or samples that better imitate the sample space of the sample database 315. Discriminators in accordance with a number of embodiments of the invention can learn to discriminate between high-efficiency and low-efficiency devices, biasing the generator to high-efficiency regions of the device space. Optimizers in accordance with various embodiments of the invention can be used to optimize the outputs of a generator to ensure that the generated designs are feasible and optimized for efficiency. In a variety of embodiments, filter modules are used to target optimization and/or retraining on highly efficient samples based on simulated performance.

Although a specific example of a training and generation application is illustrated in FIG. 3, any of a variety of training and generation applications can be utilized to perform processes similar to those described herein as appropriate to the requirements of specific applications in accordance with embodiments of the invention.

### Training for Generative Design

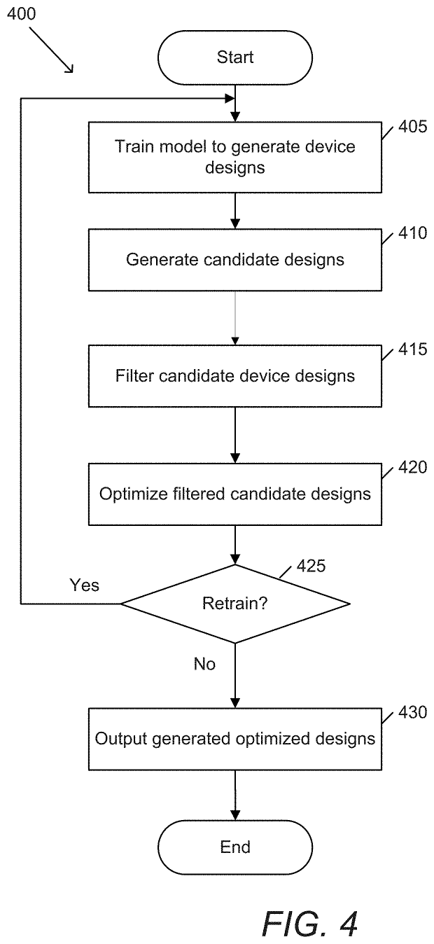

A process for training a model to generate candidate device designs in accordance with an embodiment of the invention is conceptually illustrated in FIG. 4. Process 400 trains (405) a model to generate device designs. Training a model in accordance with numerous embodiments of the invention can include training on generated images. In several embodiments, models can be trained based on optimized versions of the generated images, while in other embodiments, models can be trained without any optimization of the generated images. In numerous embodiments, trained models can include (but are not limited to) deconvolutional networks, autoencoders, and other generative models. In certain embodiments, training data for the model is selected by initially clustering devices in the training dataset around specific, strategic metamaterial parameters, and then sparsely distributing these clusters around the full metamaterial parameter space in order to effectively train the model in the face of sparse data.

In many GAN implementations, such as the image generation of faces or furniture, there are no quantitative labels that can be used to evaluate the quality of training or generated datasets. Training in accordance with several embodiments of the invention can quantify the quality of the training and generated data by evaluating device efficiency using an electromagnetics solver (e.g., Reticolo RCWA electromagnetic solver in MATLAB). In numerous embodiments, for a fraction of network training iterations, network loss is directly calculated as a function of the efficiencies of the training and generated devices, as evaluated with an electromagnetics solver. This value can then back-propagated to improve the networks in a manner that matches with the desired physical output in accordance with some embodiments of the invention. The discriminator can directly learn to differentiate between low and high efficiency devices, while the generator can directly learn to generate high efficiency devices.

Process 400 uses the trained model to generate (410) candidate device designs. Trained models in accordance with certain embodiments of the invention are conditional GANs that can be trained to produce outputs with a specified set of parameters. In a number of embodiments, candidate devices include devices with extrapolated parameters that are specified to lie outside of the range of parameters used to train the model. Process 400 filters (415) the candidate device designs to identify the best candidate device designs. The best candidate device designs in accordance with a variety of embodiments of the invention are determined based on a simulation of the performance or efficiency of a candidate design. In a variety of embodiments, filtering the candidate devices can include (but is not limited to) one or more of selecting a certain number of candidate devices, selecting a percentage of the candidate devices, and sampling a diverse sample of candidate devices from a range of simulated performance.

Process 400 optimizes (420) the filtered candidate device designs. Optimizing the filtered candidate device designs in accordance with numerous embodiments of the invention can improve the device efficiencies, incorporate robustness to fabrication imperfections, and enforce other experimental constraints within the candidate device designs. Process 400 determines (425) whether to retrain the generator model. In a number of embodiments, processes can determine to retrain a generator model based on any of a number of criteria, including (but not limited to) after a predetermined period of time, after a number of candidate designs are optimized, after a threshold simulated performance is reached, etc. When process 400 determines (425) to retrain the generator model, the process returns to step 405 to retrain the model using the generated optimized designs. In certain embodiments, retraining models based on generated, optimized, and extrapolated designs can allow a retrained model to generate better candidates for further extrapolated designs. Retraining in accordance with various embodiments of the invention uses the generated designs as new ground truth images to retrain the generator based on new features identified in the generated designs. When process 400 determines (425) that the model is not to be retrained, the process outputs (430) the generated optimized designs. In certain embodiments, processes can use generated optimized designs both for retraining and as output of the generation process. The generated optimized designs in accordance with various embodiments of the invention can be used to fabricate and characterize high efficiency beam deflectors and lenses.

Although various processes for training models and generating device designs are discussed above with reference to FIG. 4, other processes that add, omit, and/or combine steps may be performed in accordance with other embodiments of the invention.

### Metagratings

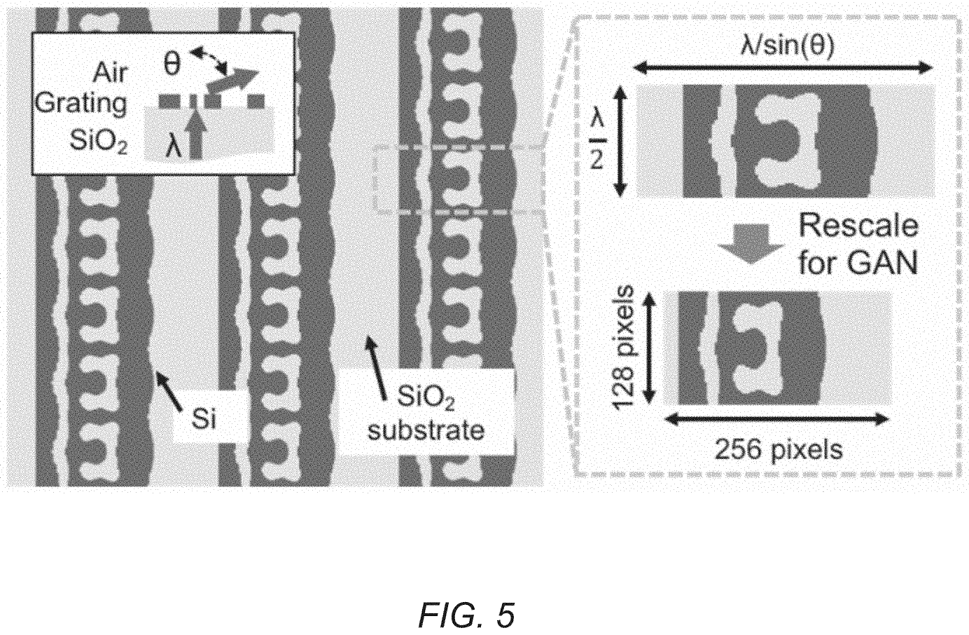

In some embodiments, processes in accordance with a variety of embodiments of the invention produce a high-quality training dataset consisting of high-resolution images of topology-optimized metagratings. Example silicon metagratings are illustrated in FIG. 5. This example illustrates a top view image of a typical topology-optimized metagrating that selectively deflects light to the +1 diffraction order. Training images of single metagrating unit cells in accordance with a variety of embodiments of the invention are scaled or normalized (e.g., to a 128 by 256 pixel grid) before being input to a generative model.

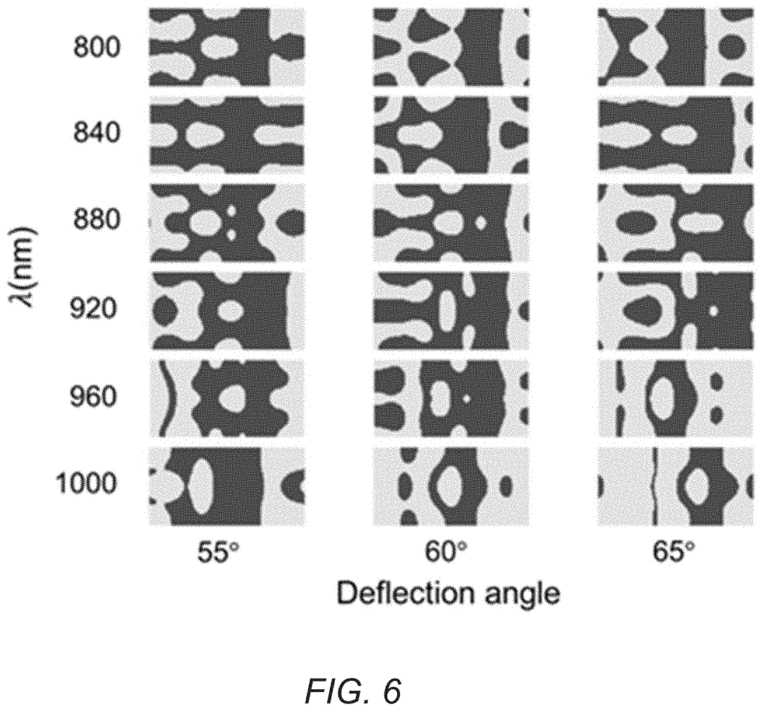

Representative images from a training dataset in accordance with many embodiments of the invention are shown in FIG. 6. In this example, each device deflects TE-polarized light with over 75% efficiency, and is designed to operate for a specific deflection angle and wavelength. In numerous embodiments, devices consist of polycrystalline silicon on a glass substrate and deflect normally-incident TE-polarized electromagnetic waves to the +1 diffraction order. Devices in accordance with a number of embodiments of the invention are designed using adjoint-based topology optimization, are robust to experimental fabrication variations, and have efficiencies over 75%. In several embodiments, each device is 325 nm thick and designed to operate at a wavelength between 800 nm to 1000 nm, in increments of 20 nm, and at an angle between 55 and 65 degrees, in increments of 5 degrees.

### Generator Architecture

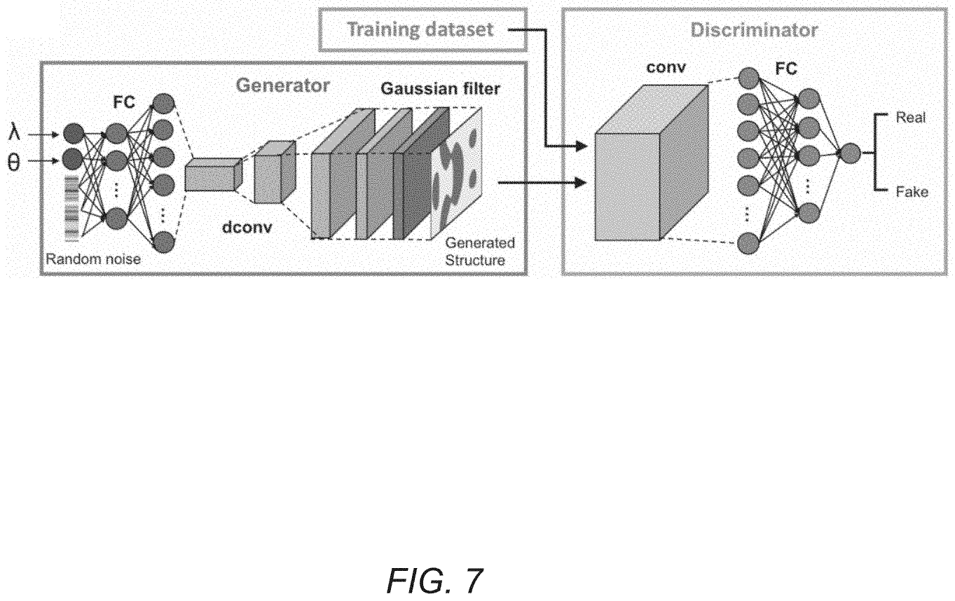

Conditional GANs in accordance with a variety of embodiments of the invention consist of two separate networks, a generator and a discriminator. An example of a conditional GAN in accordance with an embodiment of the invention is illustrated in FIG. 7. In this example, a target deflection angle θ, target operating wavelength λ, and random noise are fed into a generator. The generator utilizes two fully connected (FC) and four deconvolution (dconv) layers, followed by a Gaussian filtering layer, while the discriminator utilizes one convolutional (cony) layer and two fully connected layers. GAN generators can create slightly noisy patterns with very small features that are not present in devices in the training dataset, because the devices in the training dataset are robust to fabrication errors and minimally utilize small feature sizes. To generate devices that better mimic those from the training dataset, processes in accordance with numerous embodiments of the invention add a Gaussian filter at the end of the generator, before the tanh layer, to eliminate any fine features in the generated devices.

The network structure of the elements of a specific example of a conditional GAN in accordance with a variety of embodiments of the invention is described in the tables below.

Generator

| | | filter | |
|---|---|---|---|
| | | size/ | |
| Type | size | stride | channels |
| FC | 512 | | |
| FC | 4096 | | |
| Reshape | 16 × 64 | | 4 |
| Dconv | | 5 × 5/2 | 64 |
| batch_norm | | | |
| leaky_relu | | | |
| Dconv | | 5 × 5/2 | 32 |
| batch_norm | | | |
| leaky_relu | | | |
| Dconv | | 5 × 5/2 | 16 |
| batch_norm | | | |
| leaky_relu | | | |
| Dconv | | 5 × 5/1 | 1 |
| Gaussian | | 3 × 3/1 | |
| Filter | | σ = 2 | |
| Tanh | | | |

Discriminator

| | | filter | |
|---|---|---|---|
| | | size/ | |
| type | size | stride | channels |
| conv | | 5 × 5/2 | 64 |
| leaky_relu | | | |
| FC | 512 | | |
| layer_norm | | | |
| leaky_relu | | | |
| FC | 512 | | |
| layer_norm | | | |
| leaky_relu | | | |
| FC | 1 | | |
| sigmoid | | | |

The input to the generator is a 128×1 vector of Gaussian random variables, the operating wavelength λ, and the output deflection angle θ. In a variety of embodiments, these input values can be normalized to numbers between −1 and 1. In a number of embodiments, the output of the generator, as well as the input to the discriminator, can include binary images on a 64×256 grid, which is half of one unit cell. Mirror symmetry along the y-axis can enforced by using reflecting padding in the convolution and deconvolution layers in accordance with many embodiments of the invention. In many embodiments, periodic padding can be used to capture the periodic nature of the metagratings. In some embodiments, the training dataset can be augmented by including multiple copies of the same devices in the training dataset, with each copy randomly translated along the x-axis.

Generators in accordance with a number of embodiments of the invention can be trained to produce images of new devices. Inputs for generators can include (but are not limited to) one or more of the metagrating deflection angle θ, operating wavelength λ, and/or an array of normally-distributed random numbers, which can provide diversity to the generated device layouts. In a number of embodiments, discriminators can be trained to distinguish between actual devices from the training dataset and those from the generator.

The training process can be described as a two-player game in which the generator tries to fool the discriminator by generating real-looking devices, while the discriminator tries to identify and reject generated devices from a pool of generated and real devices. In this manner, the discriminator serves as a simulator that evaluates the performance of the generator and learns based on this information. In numerous embodiments, a generator and a discriminator are alternately trained over many iterations, and each network improves after each iteration. Upon completion, generators in accordance with numerous embodiments of the invention will have learned the underlying topological features from optimized metagratings, and will be able to produce new, topologically complex devices for a desired deflection angle and wavelength input. The diversity of devices produced by the generator reflect the use of a random noise input in a probabilistic model.

A specific example of an implementation of a conditional generative network, with specific hyperparameters and other details, in accordance with a number of embodiments of the invention is described below. However, one skilled in the art will recognize that many different hyperparameters and models can be used without departing from the essence of the invention.

In this example, during the training process, both the generator and discriminator use an optimizer (e.g., the Adam optimizer, gradient descent, etc.) with a batch size of 128, learning rate of 0.001, beta1 of 0, and beta2 of 0.99. The improved Wasserstein loss is used with a gradient penalty, with lambda=10. (31,32). In this example, the network was trained on one Tesla K80 GPU for 1000 iterations, which takes about 5 minutes.

### Results

Generators in accordance with many embodiments of the invention can be trained to produce different layouts of devices operating at a given degree deflection angle (e.g., 70 degrees) and a given wavelength (e.g., 1200 nm). At 1200 nm, the operating wavelength is red-shifted beyond those of all devices used for training. Device generation, even for thousands of devices, is computationally efficient and takes only a few seconds using a standard computer processing unit. In several embodiments, device efficiencies can be calculated using a rigorous coupled-wave analysis solver (e.g., full-wave Maxwell solvers).

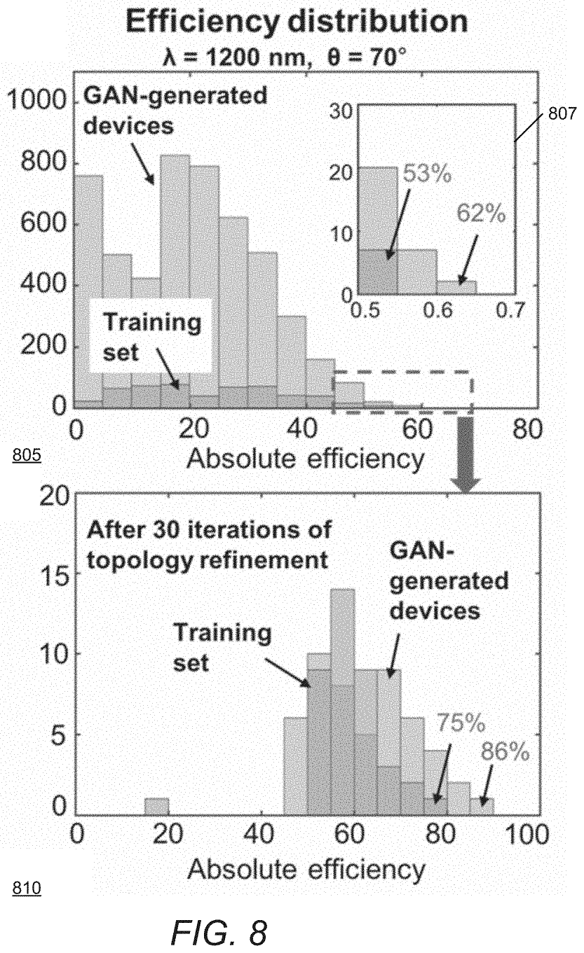

Device efficiency distributions for devices generated in accordance with an embodiment of the invention are illustrated in FIG. 8. The distribution of efficiencies for the described example is plotted as a histogram in the first part 805 of FIG. 8. As a reference, the deflection efficiencies of devices in the training dataset that have been geometrically stretched, such that they diffract 1200 nm light to 70 degrees have also been calculated and plotted. The histogram of device efficiencies produced from the generative design system shows a broad distribution. Notably, there exist devices in the distribution with efficiencies over 60% and as high as 62%, as seen in the magnified view of the histogram for large efficiency values of inset image 807. The presence of these devices indicates that generative design systems in accordance with several embodiments of the invention are able to learn features from the high efficiency metasurfaces in the training dataset. The deflection efficiencies of devices based on the training dataset patterns have a more limited distribution, with a maximum efficiency of only 53%. Part of the success of the generator is attributed to its ability to efficiently generate a large number of devices with diverse geometric features. In this example, the number of devices produced and tested from the generator is nearly an order of magnitude larger than the entire training dataset.

In various embodiments, high efficiency devices produced by the generative design system can be further refined with iterative topology optimization. This additional refinement serves multiple purposes. First, it can further improve the device efficiencies. Second, it can incorporate robustness to fabrication imperfections into the metagrating designs, which makes experimentally fabricated devices more tolerant to processing defects. Third, it can enforce other experimental constraints, such as grid snapping or minimum feature size. In several embodiments, relatively few iterations (e.g., ˜30 iterations) of topology optimization can be used at this stage, because the devices from the generative design system are already highly efficient and near a local optimum in the design space.

In this example, the performance of devices produced by the generative design system is quantified by simulating the diffraction efficiencies of the generated devices with the RCWA solver Reticolo. A test dataset consisting of 935,000 generated devices was used. The wavelengths of these devices range from 500 nm to 1300 nm with a step size of 50 nm, and the target deflection angles range from 35 degrees to 85 degrees with a step size of 5 degrees. There are 5000 device instances of each wavelength and deflection angle combination. The simulations were run in parallel on the Stanford computing cluster Sherlock, and the computation time was 15 seconds per device. The 50 most efficient devices for each wavelength and deflection angle combination (indicated by the dashed box) were then iteratively refined with adjoint-based topology optimization. Because the GAN output patterns are quite close to optimal patterns, relatively few iterations are required to refine them.

The final device efficiency distributions are plotted in the second part 810 of FIG. 8 and show that the highest performance device has an efficiency of 86%. As a reference, the 50 highest efficiency devices from the training dataset were also topology refined, but the highest performance device after optimization from the training dataset has an efficiency of only 75%. The superior performance of the best GAN-generated devices over those from the training dataset suggests that generators in accordance with numerous embodiments of the invention are able to extrapolate the topological features of high efficiency devices beyond the training dataset parameter space.

With topology refinement in accordance with a number of embodiments of the invention, devices can be optimized to be robust to geometric erosion and dilation. To enforce physical robustness constraints in the generated designs, modifications to the GAN can be made at the network architecture level and in the training process in accordance with numerous embodiments of the invention. Robustness constraints can be essential to generating devices that are tolerant to random experimental fabrication perturbations. Devices defined by an “intermediate” pattern are robust to both global and local perturbations if their geometrically “eroded” and “dilated” forms are also high efficiency. At an architectural level, these robustness criteria can be mimicked in the GAN discriminator by using image sets of the intermediate, eroded, and dilated devices as inputs. By enforcing low network loss for these sets of devices, the robustness properties of the training set devices can be learned by the generator.

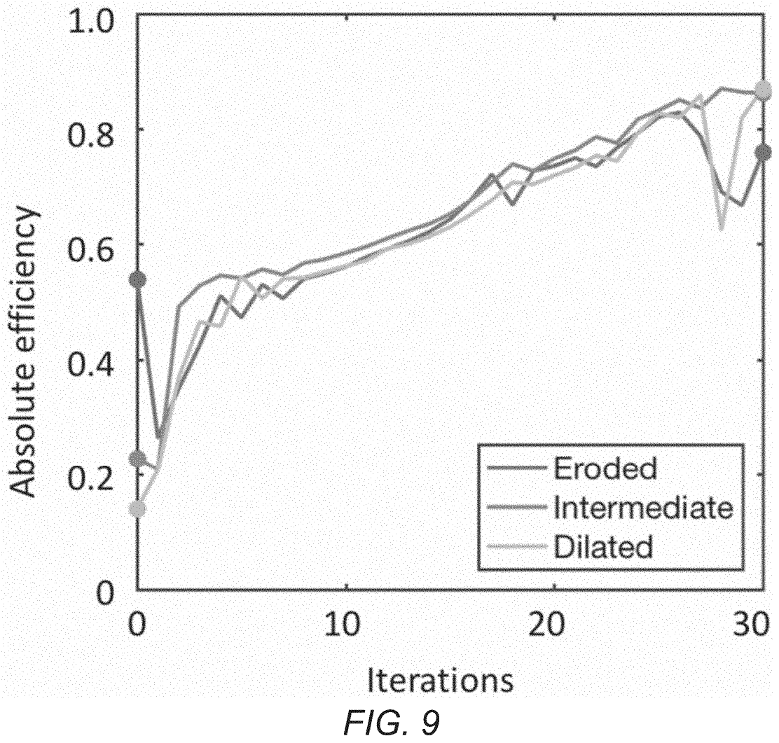

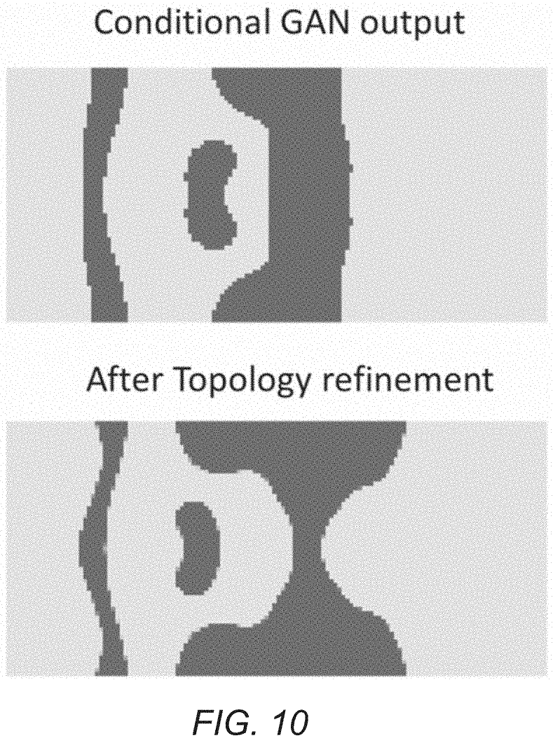

FIG. 9 shows the efficiencies of the eroded, intermediate, and dilated device geometries over the course of topology optimization for the highest efficiency device presented in the second part 810 of FIG. 8. Efficiency of the eroded, dilated and intermediate devices is illustrated as a function of iteration number. Topology refinement improves device efficiency and robustness, but the shape of the device does not significantly change. An example of a top view of a metagrating unit cell before and after topology refinement is illustrated in FIG. 10. This topological refinement can take about 60-70 minutes on a personal computer (16G RAM, 4 CPU cores). In contrast, to produce devices for the training dataset, devices in accordance with certain embodiments of the invention are optimized using an initial random grayscale dielectric distribution. In this example, 350 iterations of adjoint-based topology optimization are required, which takes 800-900 minutes and 12-15× longer than the topology refinement step. These simulation times account for the fact that simulations of grayscale dielectric distributions take longer than those of binarized dielectric distributions.

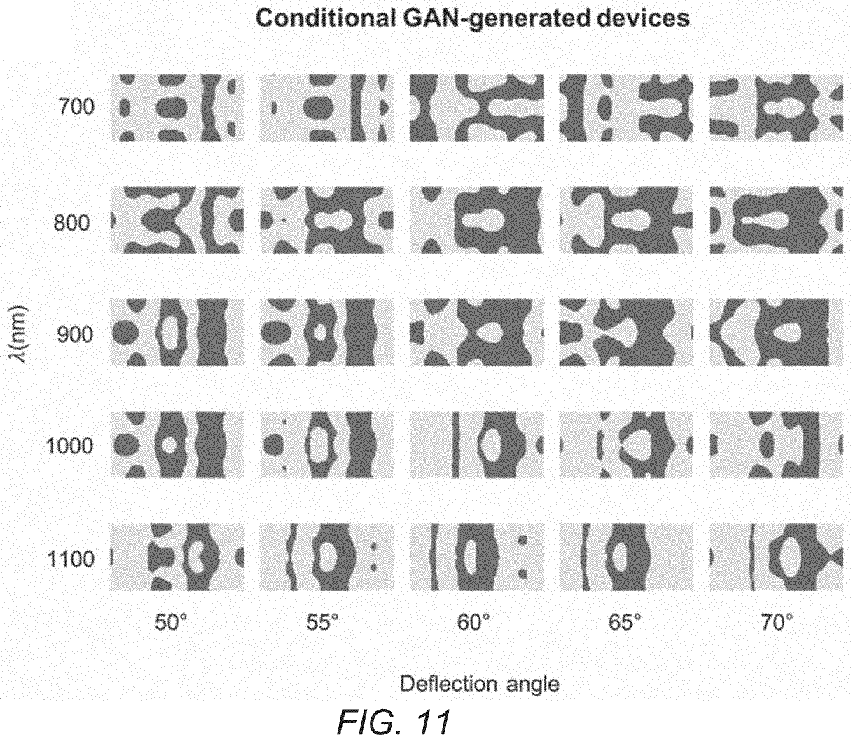

Representative images of high efficiency metagratings from the generator are shown in FIG. 11. At shorter wavelengths, metagratings generally comprise spatially distributed dielectric features. As the wavelengths get longer, the devices exhibit more consolidated distributions of dielectric material with fewer voids. These variations in topology are often qualitatively similar to those featured in the training dataset. Furthermore, the examples shown in FIG. 11 show that these trends in topology extend to devices operating at wavelengths of 700 nm and 1100 nm, which are parameters outside of those used in the training dataset. In a number of embodiments, a Gaussian noise array input enables diversity to the generated device layouts.

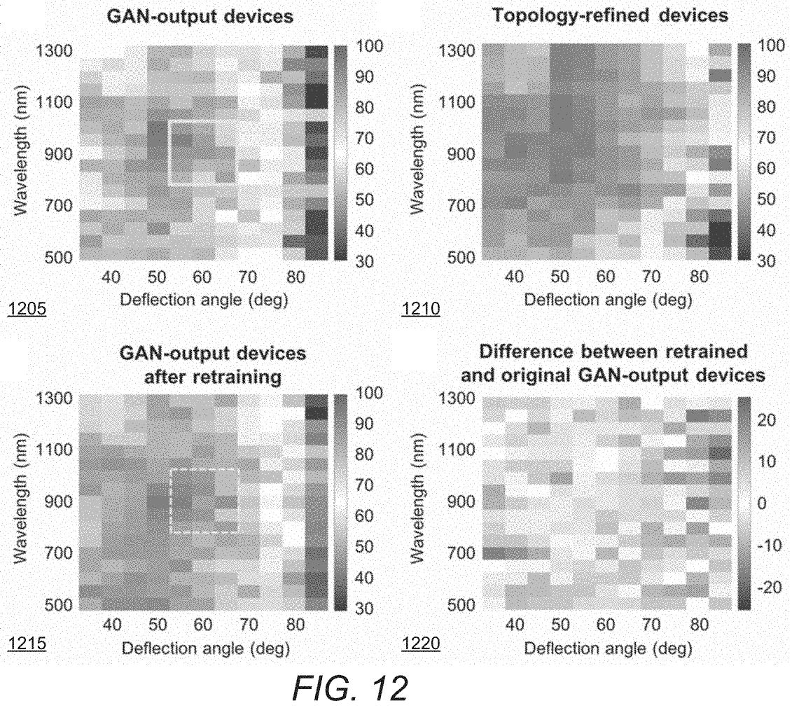

Designing robust, high-efficiency metagratings with the GAN generator and iterative optimizer can be applied to a broad range of desired deflection angles and wavelengths. With the same training data from before, robust metagratings can be designed with operating wavelengths ranging from 500 nm and 1300 nm, in increments of 50 nm, and angles ranging from 35 and 85 degrees, in increments of 5 degrees. In a number of embodiments, models can be trained to generate devices with parameters beyond the parameters found in a training dataset. Processes in accordance with numerous embodiments of the invention train a model by iteratively generating extended training samples (i.e., training samples with parameters incrementally beyond the current training dataset) and training the conditional generator on the extended training samples. A plot of device efficiencies for metagratings produced by an example GAN generator is illustrated in the first chart 1205 of FIG. 12. 5000 devices were initially generated and characterized for each angle and wavelength, and topology refinement is performed on the 50 most efficient devices. Chart 1205 shows the device efficiencies from the generator, where the efficiencies of the highest performing devices for a given angle and wavelength are presented. Most of the generated devices have efficiencies over 65%, and within and near the parameter space specified by the training dataset (center box), the generated devices have efficiencies over 75%.

Chart 1210 shows a plot of the device efficiencies of the best generated devices after topology refinement. Nearly all the metagratings with wavelengths in the 600-1300 nm range and angles in the 35-75 degree range have efficiencies near or over 80%. These data indicate that a conditional GAN in accordance with a number of embodiments of the invention can broadly generalize to wavelengths and angles beyond those specified in the training dataset and effectively produce high performance devices.

Not all the devices produced with methods in accordance with some embodiments of the invention exhibit high efficiencies, as chart 1210 shows clear drop-offs in efficiencies for devices designed for shorter wavelengths and ultra-large deflection angles. One source for this observed drop-off is that these devices are in a parameter space that requires topologically distinctive features not found in the training dataset. As such, the conditional GAN can have difficulties learning the proper patterns required to generate high performance devices. In addition, there are device operating regimes for which efficient beam deflection is not physically possible with 325 nm-thick silicon metagratings. For example, device efficiency will drop off as the operating wavelength becomes substantially larger than the device thickness.

An important feature of conditional GANs in accordance with various embodiments of the invention is that the scope of its capabilities can be enhanced by network retraining with additional data. In many embodiments, the data for retraining a conditional GAN can originate from two sources. The first is from the iterative optimization of initial random dielectric distributions, which is how the initial metagrating training dataset is produced in accordance with a variety of embodiments of the invention. The second is from the GAN generator and iterative optimizer themselves, which yield high efficiency devices. This second source of training data suggests a pathway to expanding the efficacy of a conditional GAN with high computational efficiency.

As a proof-of-concept, the generator and iterative optimizer is used to produce 6000 additional high efficiency (70%+) robust metagratings with wavelengths and angles spanning the full parameter space. A plot of device efficiencies for metagratings produced by a GAN generator retrained on the generated metagratings is illustrated in chart 1215 of FIG. 12. The range of parameters covered by the initial training dataset used in 1205 is outlined by the dashed box. These data are added to the previous training dataset and the conditional GAN is retrained. Chart 1215 shows the device efficiencies from the retrained generator, where 5000 devices for a given angle and wavelength are generated and the efficiencies of the highest performing devices are presented. The plot shows that the efficiency values of devices produced by the retrained GAN generally increase in comparison to those produced by the original GAN.

Chart 1220 illustrates a plot of differences in device efficiencies between those produced by the retrained GAN generator in 1215 and those produced by the initial GAN generator in 1205. Quantitatively, over 80% of the devices in the parameter space have improved efficiencies after retraining as illustrated in chart 1220. For all plots in FIG. 12, the efficiencies of the highest performing devices for a given angle and wavelength are presented.

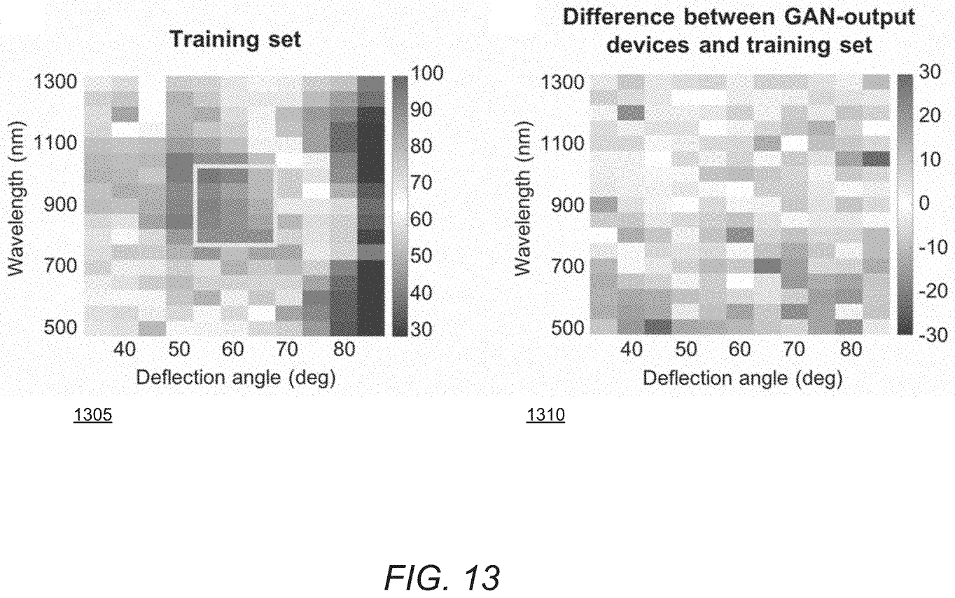

A comparison between the generated output devices and the training dataset is described below. Chart 1305 of FIG. 13 illustrates the calculated deflection efficiencies of devices in the training dataset that have been geometrically scaled to operate over differing wavelengths and deflection angles. The highest efficiency device for a given wavelength and deflection angle is plotted. Chart 1310 illustrates a plot of differences in device efficiencies between those produced by the GAN generator in chart 1205 of FIG. 12 and those produced by the training dataset in 1305. Within and near the operating parameters defining the training dataset, the training dataset devices have higher efficiencies than those produced by the GAN generator. This is delineated by the blue tiles in the middle of the plot. Away from those operating parameters, the GAN generator produces superior devices. This is delineated by the red tiles along the borders of the plot.

In a variety of embodiments, conditional GANs can provide clear advantages in computational efficiency compared to brute force topology optimization, in order to produce many thousands of high performance devices, including many devices for each wavelength and angle pair. In particular, with a higher dimensional parameter space, brute force optimization methods simply cannot scale, making data-driven methods a necessary route to the design of topologically-complex devices. Further, the identification of large numbers of high performance devices, as can be attained using methods in accordance with certain embodiments of the invention, can be important because it enables the use of statistical, large data analyses to deepen the understanding of the high-dimensional phase space for metasurface design. Having a diversity of device layouts for a given optical function can also be practically useful in experimental implementation to account for any constraints in the fabrication process.

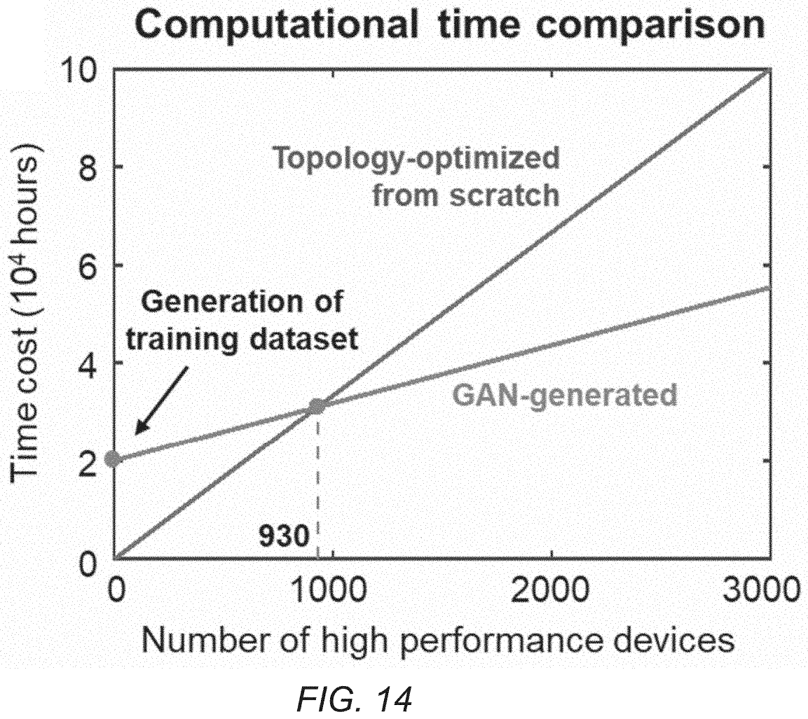

A comparison of GAN-based computation cost and network retraining efficacy results for generating devices is illustrated in FIG. 14. Specifically, the graph in this figure illustrates the computational time required to produce “above threshold” devices using a GAN-generated process and a topology-optimized process from scratch. In these examples, “above threshold” devices have efficiencies above 60th percentile of the efficiency distribution of devices from brute force topology-optimization from scratch, but other methods of thresholding devices can be used in accordance with embodiments of the invention. The total computation cost scales accordingly as a function of the total number of desired devices. The GAN-based approach requires a large initial computation cost due to the generation of training data. However, the computational cost of designing “above threshold” devices using GAN generation, evaluation, and device refinement is relatively low. The result for GAN generation produces a trend for computational cost, which has a slope approximately three times less steep than that of the topology optimized process.

The data used for this analysis are taken from a broad range of wavelength and angle pairs and are summarized in FIG. 14. In these results, the total computational cost of a GAN-based approach in accordance with several embodiments of the invention is lower than that of brute-force optimization when designing more than ˜930 devices. The advantages in computational cost scale with increasing device numbers. In addition to savings in total computational cost, there are also potential savings in total computation time when using multiple computing cores, due to the enhanced parallelizability of this design approach compared to the brute force approach.

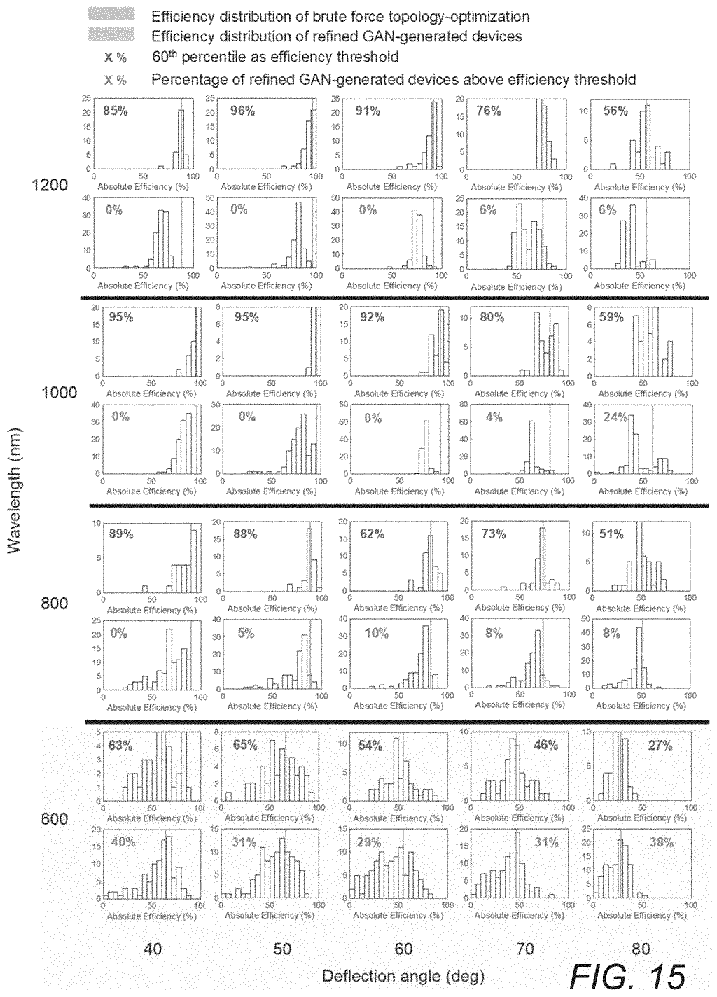

FIG. 15 illustrates efficiency distributions of brute force topology-optimization and refined GAN-generated devices at various wavelengths and deflection angles in accordance with an embodiment of the invention. Representative efficiency distributions of devices designed using brute force topology optimization from scratch (histograms in the first row for each wavelength, 50 devices/histogram) and GAN generation and topology refinement (histograms in the second row for each wavelength, 100 devices/histogram). The vertical lines and numbers represent the 60th percentile in the brute force efficiency distributions. The percentage of refined GAN-generated devices that are above this threshold are denoted by the numbers in the graphs of the second row.

| | | | | Cum. Hours Spent | |
|---|---|---|---|---|---|
| | Total | Simulation | Total | computing for | Cum. Hours required |
| | # of | time/device | cost | each wavelength/ | to design each “above |
| Step | devices | (minutes) | (hours) | deflection angle pair | threshold” device* |
| Training set: Uses 350 iterations of | 1500 | 800 | 20000 | 107.0 | 17.8 |
| topology optimization from scratch to | | | | | |
| create 1500 devices. The top 40% are | | | | | |
| screened out and form the training | | | | | |
| dataset. | | | | | |
| GAN generation: 5000 devices for each | 935000 | 0.25 | 3896 | 127.8 | 21.3 |
| target (wavelength, angle) are | | | | | |
| generated, and their efficiencies are | | | | | |
| evaluated using RCWA. | | | | | |
| GAN refinement: 30 iterations of | 9350 | 60 | 9350 | 177.8 | 29.6 |
| topology refinement are performed for | | | | | |
| top 50 devices from the previous step, | | | | | |
| for each wavelength and deflection | | | | | |
| angle pair. | | | | | |

The table above illustrates the computational cost of device generation and refinement using a conditional GAN in accordance with a variety of embodiments of the invention. The average percentage of refined GAN-generated devices that are “above threshold” is 12% (as shown in FIG. 15). Therefore the number of “above threshold” devices is 12%×9350=1122. The average number of hours required to produce a “above threshold” device is approximately 30 hrs.

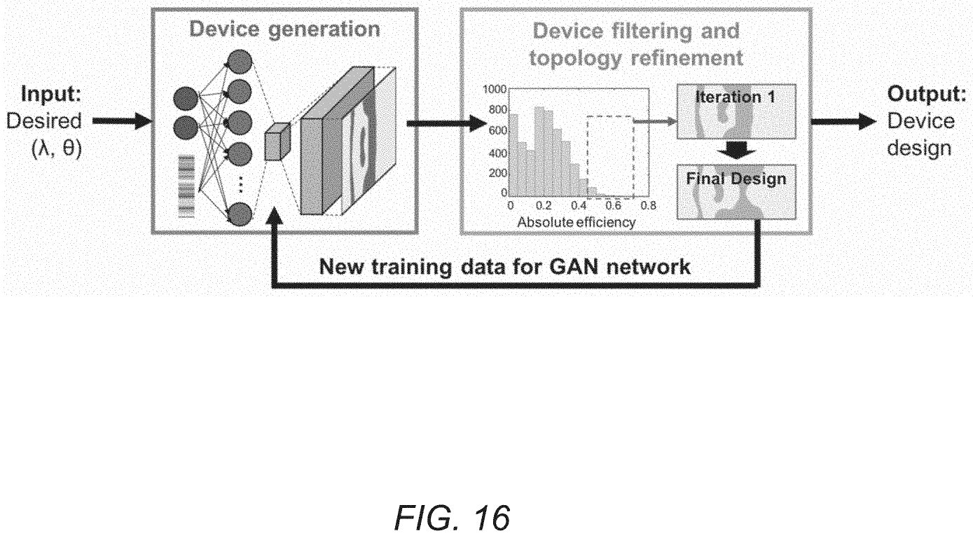

An illustration of the overall design platform is illustrated in FIG. 16. To produce metagratings with a desired set of device parameters, systems in accordance with numerous embodiments of the invention use a conditional GAN to generate many candidate device images, with a diversity of geometric shapes made possible by the random number array input. These devices can be characterized using a high-speed electromagnetics simulator. Processes can then filter for devices that have high efficiencies. In many embodiments, processes can use optimization to refine these patterns and incorporate experimental constraints and robustness into the designs. In some embodiments, these final metagrating layouts can serve as the new training dataset to retrain the conditional GAN and expand its overall capabilities. This method of GAN refinement can be performed iteratively in an automated manner, where the input device parameters are specified to be near but not overlapping with those in the training dataset, and the output devices are used for network retraining.

In summary, generative neural networks can facilitate the computationally efficient design of high performance, topologically-complex metasurfaces. Neural networks are a powerful and appropriate tool for this design problem for two reasons. First, there exists a strong interdependence between device topology and optical response, particularly for high performance devices. Second, using the combination of iterative optimizers and accurate electromagnetic solvers allows for the generation of high quality training data and validate device performance. Data-driven design processes in accordance with various embodiments of the invention can apply to the design and characterization of other complex nanophotonic devices, ranging from dielectric and plasmonic antennas to photonic crystals. One skilled in the art will recognize that methods in accordance with several embodiments of the invention can be similarly applied to the design of devices and structured materials in other fields, such as (but not limited to) acoustics, mechanics, and electronics, where there exist strong relationships between structure and response.

In various embodiments, generative neural networks can produce high efficiency, topologically complex metasurfaces in a highly computationally efficient manner. As a model system, conditional generative adversarial networks can be utilized to produce highly-efficient metagratings over a broad range of deflection angles and operating wavelengths. Generated device designs in accordance with a number of embodiments of the invention can be further locally optimized and/or serve as additional training data for network refinement. Data-driven design tools in accordance with numerous embodiments of the invention can be broadly utilized in other domains of optics, acoustics, mechanics, and electronics.

### Global Optimization

Systems and methods in accordance with various embodiments of the invention present a novel global optimization method that can optimize the generation of various elements, such as (but not limited to) metagratings, grating couplers, on-chip photonic devices (splitters, mode converters, etc.), scalar diffractive optics, optical antennas, and/or solar cells. Global optimization methods in accordance with various embodiments of the invention can also be used to optimize other types of systems such as (but not limited to) acoustic, mechanical, thermal, electronic, and geological systems. The inverse design of metasurfaces is a non-convex optimization problem in a high dimensional space, making global optimization a huge challenge. In various embodiments, processes can combine adjoint variables electromagnetic calculations with a generative neural network to realize high performance photonic structures.

While approaches in accordance with some embodiments of the invention can use adjoint-based gradients to optimize metagrating generation, it is qualitatively different from adjoint-based topology optimization. Adjoint-based topology optimization, as applied to a single device, is a local optimizer. The algorithm takes an initial dielectric distribution and enhances its efficiency by adjusting its refractive indices at each segment using gradient descent. This method is performed iteratively until the device reaches a local maximum in the design space. The performance of the final device strongly depends on the choice of initial dielectric distribution. These local optimizers can be used in a global optimization scheme by performing topology optimization on many devices, each with different initial dielectric distributions that span the design space. Devices that happen to have initial dielectric distributions near favorable regions of the design space will locally optimize in those regions and become high performing.

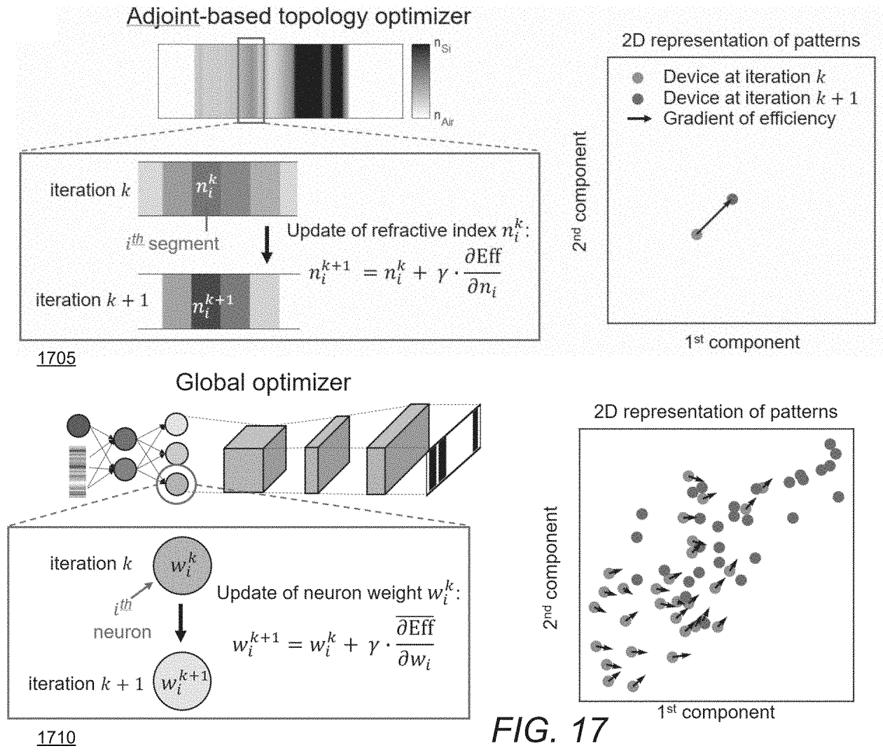

A comparison between adjoint-based topology optimization and global optimization is illustrated in FIG. 17. In the first portion 1705, adjoint-based topology optimization uses efficiency gradients to improve the performance of a device within the local design space. In this figure, a visualization of the device in a 2D representation of the design space illustrates that from iteration k to k+1, the device moves incrementally to a nearby local maxima, indicated by its local gradient. By comparison, processes in accordance with certain embodiments of the invention can use a neural network to map random noise to a distribution of devices. Efficiency gradients are backpropagated to update the weights of the neurons and deconvolution kernels and improve the average efficiency of the device distribution. In the second portion 1710, a visualization of the device distribution illustrates that from iteration k to k+1, the efficiency gradients from individual devices (black arrows) are used to collectively bias the device distribution towards high efficiency regions of the design space.

This global approach with topology optimization is an effective route to designing a wide range of photonic devices. However, its usage is accompanied by a number of caveats. First, it requires significant computational resources. Hundreds of electromagnetic simulations are required to topology optimize a single device, and for many devices, this number of simulations can scale to very large numbers. Second, the sampling of the design space is limited to the number of devices being optimized. For complex devices described by a very high dimensional design space, this sampling may be insufficient. Third, the devices locally optimize independently of one another, such that gradient information from one device does not impact other devices. As a result, it is not possible for the optimizer to explore beyond the local design spaces demarcated by the initial device distributions.

Approaches in accordance with various embodiments of the invention are qualitatively different in that they can optimize an entire distribution of device instances, as represented by the noise vector. In a variety of embodiments, the starting point of each iteration is similar to adjoint optimization and involves the calculation of efficiency gradients for individual devices using the adjoint method. However, the difference arises when these gradients are backpropagated into the network. When considering the backpropagation of the efficiency gradient from even a single device, all the weights in the network get updated, thereby modifying the mapping of the entire distribution of device instances to device layouts. This points to the presence of crosstalk, in which the gradients from one device instance influence other device instances. Crosstalk is useful because devices in promising parts of the design space exhibit particularly large gradients and can more strongly bias the overall distribution of device instances to these regions. Devices stuck in sub-optimal local maxima of the design space can be biased away from these regions. Regulation of the amount of crosstalk between devices, which is important to stabilizing the optimization method, can be achieved from the non-linearity intrinsic to the neural network itself.

Approaches in accordance with numerous embodiments of the invention are effective at broadly surveying the design space, enhancing the probability that optimal regions of the design space are sampled and exploited. Such global surveying is made possible in part because the input noise in accordance with several embodiments of the invention represents a continuum of device instances spanning the high dimensional design space, and in part because different subsets of devices can be sampled in each iteration, leading to the cumulative sampling of different regions of the design space. Further, systems and methods in accordance with certain embodiments of the invention can enable the simultaneous optimization of devices designed across a continuum of operating parameters in a single network training session. In the case of metagratings, these parameters can include the outgoing angle and wavelength, each spanning a broad range of values. This co-design can lead to a substantial reduction in computation time per device and is made possible because these devices operate with related physics and strongly benefit from crosstalk from the network training process.

### Example Problem

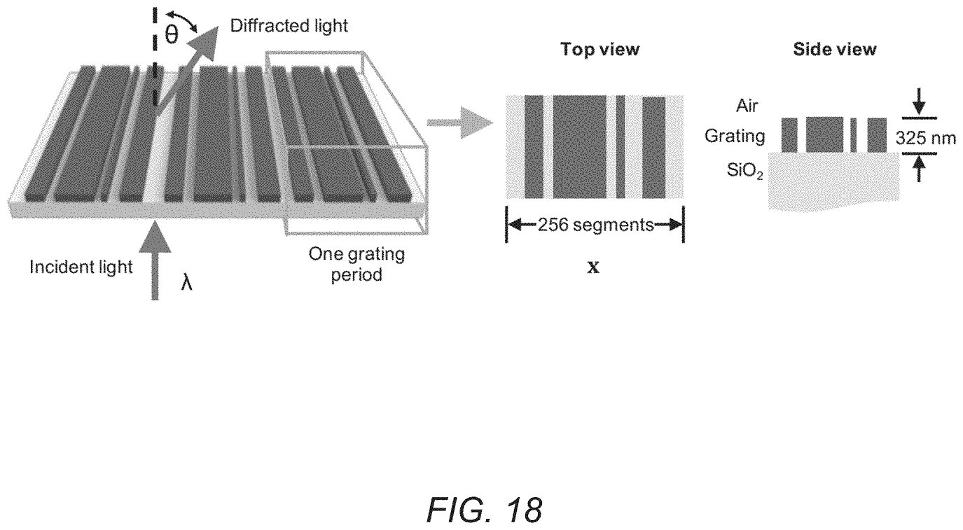

An example schematic of a silicon metagrating that deflects normally-incident transverse magnetic (TM)-polarized light of wavelength to an outgoing angle θ is illustrated in FIG. 18. The metagrating consists of 325 nm-thick Si ridges in air on a SiO₂ substrate. In generative design networks in accordance with a number of embodiments of the invention, the device is specified by a 1×256 vector, n, which represents the refractive index profile of one period of the grating.

The objective of optimization is to search for the metagrating pattern that maximizes deflection efficiency. In this example, the metagratings consist of silicon nanoridges and deflect normally-incident light to the +1 diffraction order. The thickness of the gratings is fixed to be 325 nm and the incident light is TM-polarized. For each period, the metagrating is subdivided into N=256 segments, each possessing a refractive index value between silicon and air during the optimization process. These refractive index values are the design variable in our problem and are specified as x (a 1×N vector).

The deflection efficiency is defined as the power of light going into the desired direction of deflection angle θ normalized to power of incident light. The deflection efficiency is a nonlinear function of index profile Eff=Eff(x), governed by Maxwell's equations. This quantity, together with the electric field profiles within a device, can be accurately solved using a wide range of electromagnetic solvers.

In numerous embodiments, an optimization objective can be to maximize the deflection efficiency of the metagrating at a specific operating wavelength λ and outgoing angle θ:

$${x}^{*} \text{:=} \begin{matrix}argmax \\ x ∈ {\{ - 1 , 1 \}}^{N}\end{matrix} Eff ( x ) \qquad ( 1 )$$

Here, physical devices that possess binary index values in the vector: x∈{−1,1}^{N} are of particular interest, where −1 represents air and +1 represents silicon.

### Methods

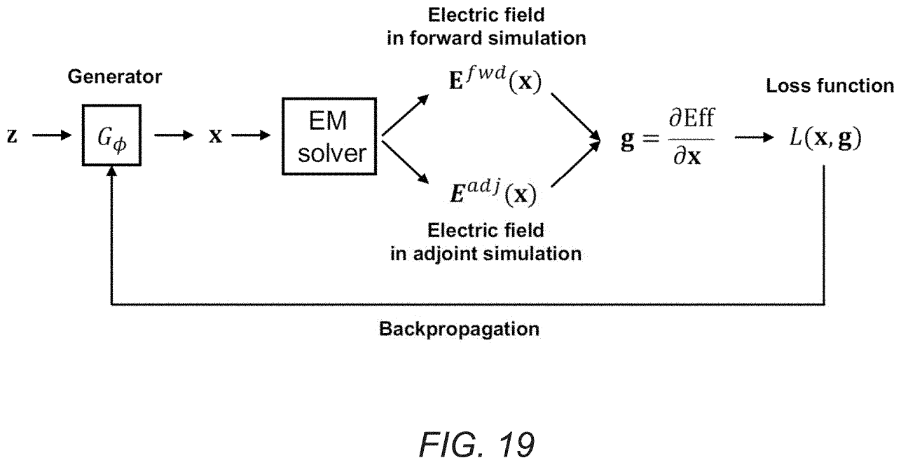

A schematic of a generative neural network-based optimization in accordance with an embodiment of the invention is illustrated in FIG. 19. In a variety of embodiments, generative neural network-based optimizations can be performed by generative design applications as described above. Generative design applications in accordance with a variety of embodiments of the invention can be performed on a single processor, a number of processors on a single machine, or may be distributed across multiple processors across multiple machines.

Instead of directly optimizing a single device, which is the case of the adjoint variables method, processes in accordance with several embodiments of the invention can optimize a distribution of devices by training a generative neural network. In many embodiments, processes do not require any pre-prepared training data. In a variety of embodiments, the input of the generator can be a random noise vector z∈ [symbol] (−a, a) and has the same dimension as the output device index profile x∈[−1,1]N. a is the noise amplitude. The generator can be parameterized by ϕ, which relates z to x through a nonlinear mapping: x=G_{ϕ}(z). In other words, the generator maps a uniform distribution of noise vectors to a device distribution G_{ϕ}: [symbol] (−a, a) [symbol] P_{ϕ}, where P_{ϕ}(x) defines the probability of x in device space [symbol] =[−1,1]^{N}.

In a number of embodiments, objectives of the optimization can be framed as maximizing the probability of the highest efficiency device in S:

$${ϕ}^{*} \text{:=} \begin{matrix}argmax \\ ϕ\end{matrix} {\int }_{S} δ ( Eff ( x ) - {Eff}_{max} ) \cdot {P}_{ϕ} ( x ) dx \qquad ( 2 )$$

While such an objective function is rigorous, it cannot be directly used for network training due to two reasons. The first is that the derivative of the δ function is nearly always zero. To circumvent this issue, the δ function can be rewritten as the following:

$$δ ( Eff ( x ) - {Eff}_{max} ) = {lim}_{σ \to 0} \frac{1}{\sqrt{π} σ} exp [ - {( \frac{Eff ( x ) - {Eff}_{max}}{σ} )}^{2} ] \qquad ( 3 )$$

By substituting the δ function with this Gaussian form and leaving σ as a tunable parameter, Equation 2 can be relaxed to become:

$${ϕ}^{*} \text{:=} \begin{matrix}argmax \\ ϕ\end{matrix} {\int }_{S} exp [ - {( \frac{Eff ( x ) - {Eff}_{max}}{σ} )}^{2} ] \cdot {P}_{ϕ} ( x ) dx \qquad ( 4 )$$

The second reason is that the objective function depends on the maximum of efficiency Effₘₐₓ, which is unknown. To address this problem, Equation 4 can be approximated with a different function, namely the exponential function:

$${ϕ}^{*} \text{:=} \begin{matrix}argmax \\ ϕ\end{matrix} {\int }_{S} exp ( \frac{Eff ( x ) - {Eff}_{max}}{σ} ) \cdot {P}_{ ϕ} ( x ) dx \qquad ( 5 )$$

This approximation works because P_{ϕ}(x|Eff(x)>Effₘₐₓ)=0 and the new function only needs to approximate that in Equation 4 for efficiency values less than Effₘₐₓ. With this approximation, Effₘₐₓ can be removed from the integral:

$${ϕ}^{*} \text{:=} \begin{matrix}argmax \\ ϕ\end{matrix} A {\int }_{S} exp ( \frac{Eff ( x )}{σ} ) \cdot {P}_{ϕ} ( x ) dx \qquad ( 6 )$$

A=exp(−Effₘₐₓ/σ) is a normalization factor and does not affect the optimization. In a number of embodiments, the precise form of the approximation function can vary and be tailored depending on the specific optimization problem.

In practice, a batch of devices {x^{(m)}}ₘ₌₁^{M} can be sampled from P. The objective function can be further approximated as:

$$\begin{matrix}{ϕ}^{*} \text{:=} \begin{matrix}argmax \\ ϕ\end{matrix} \begin{matrix}𝔼 \\ x ∼ {P}_{ϕ}\end{matrix} exp ( \frac{Eff ( x )}{σ} ) & ( 7 ) \\ \approx \begin{matrix}argmax \\ ϕ\end{matrix} \frac{1}{M} {\sum }_{m = 1}^{M} exp ( \frac{Eff ( {x}^{( m )} )}{σ} ) & ( 8 )\end{matrix}$$

In many cases, the deflection efficiency of device x can be calculated using an electromagnetic solver, such that Eff(x) is not directly differentiable for backpropagation. To bypass this problem, the adjoint variables method can be used to compute an efficiency gradient with respect to refractive indices for device x:

$$g = \frac{\partial Eff}{\partial x} .$$

To summarize, in various embodiments, the electric field terms from the forward simulation E^{fwd} can be calculated by propagating a normally-incident electromagnetic wave from the substrate to the device. The electric fields from the adjoint simulation E^{adj} can be calculated by propagating an electromagnetic wave in the direction opposite of the desired outgoing direction from the forward simulation. Efficiency gradient g in accordance with many embodiments of the invention can be calculated by integrating the overlap of those electric field terms:

$$g = \frac{\partial Eff ( x )}{\partial x} ∝ Re ( {E}^{fwd} \cdot {E}^{adj} ) \qquad ( 9 )$$

Finally, the adjoint gradients and objective function can be used to define the loss function L=L(x,g). In some embodiments, L can be defined such that minimizing L is equivalent to maximizing the objective function

$$\frac{1}{M} {\sum }_{m = 1}^{M} exp ( \frac{Eff ( {x}^{( m )} )}{σ} )$$

during generator training. With this definition, L must satisfy

$$- \frac{\partial L}{\partial {x}^{( m )}} = \frac{1}{M} \frac{\partial }{\partial {x}^{( m )}} exp ( \frac{Eff ( {x}^{( m )} )}{σ} )$$

and is defined as:

$$L ( x , g ) = - \frac{1}{M} {\sum }_{m = 1}^{M} \frac{1}{σ} exp ( \frac{{Eff}^{( m )}}{σ} ) {x}^{( m )} \cdot {g}^{( m )} \qquad ( 10 )$$

Eff^{(m)} and g^{(m)} are independent variables calculated from electromagnetic solver, which are detached from x^{(m)}. In a variety of embodiments, a regularization term −|x|·(2−|x|) can be added to L to ensure binarization of the generated patterns. This term reaches a minimum when generated patterns are fully binarized. In certain embodiments, a coefficient γ can be introduced to balance binarization with efficiency enhancement in the final loss function:

$$L ( x , g ) = - \frac{1}{M} {\sum }_{m = 1}^{M} \frac{1}{σ} exp ( \frac{{Eff}^{( m )}}{σ} ) {x}^{( m )} \cdot {g}^{( m )} - γ \cdot \frac{1}{M} {\sum }_{m = 1}^{M} \vert {x}^{( m )} \vert \cdot ( 2 - \vert {x}^{( m )} \vert ) \qquad ( 11 )$$

In numerous embodiments, the loss can then be backpropagated through the generator to update the weights of the model.

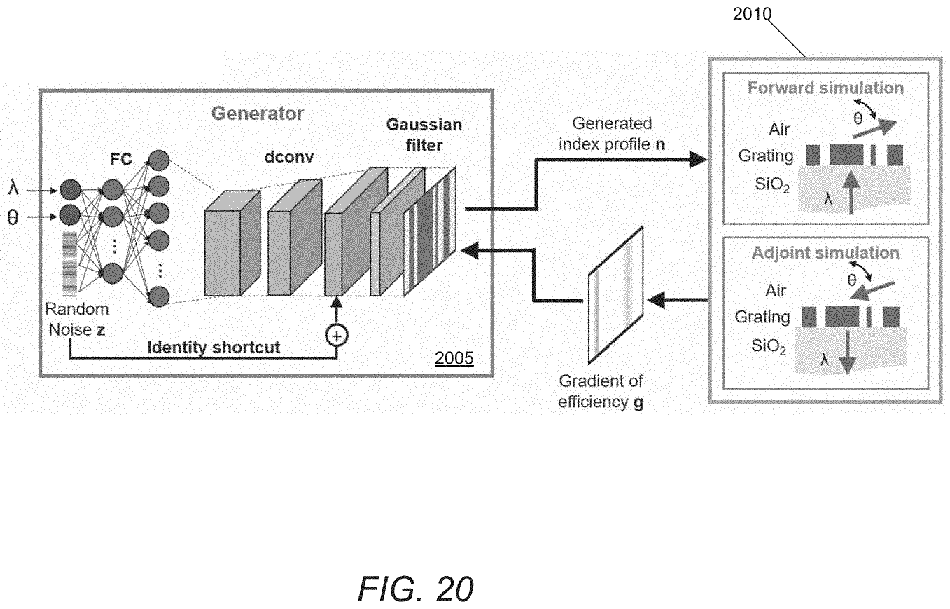

In numerous embodiments, global optimization networks can be conditional networks that can generate outputs according to particular input parameters. A schematic of a global optimization network for conditional metagrating generation in accordance with an embodiment of the invention illustrated in FIG. 20. In this example, conditional optimization network 2000 takes wavelength and deflection angle as inputs to design an ensemble of silicon metagratings that operate across a range of wavelengths and deflection angles. In this manner, conditional optimization networks can optimize multiple different devices in a training session. Optimization network 2000 includes generator 2005 and simulation engine 2010. In this example, generator 2005 includes built on fully connected layers (FC), deconvolution layers (dconv), and Gaussian filters. In this example, in addition to noise vector z, the input to generator 2005 includes operating wavelength λ and the desired outgoing angle δ. The output is the device vector n. In a variety of embodiments, during each iteration of training, a batch of devices is generated and efficiency gradients g can be calculated for each device using physics-based simulations. These gradients are backpropagated through the network to update the weights of the neurons.

The output is the refractive index values of the device, n. The weights of the neurons are parameterized as w. Initially, the weights in the network are randomly assigned and different z map onto different device instances: n=G_{w}(z; λ, θ). In this initial network state, the ensemble of noise vectors {z} maps onto an ensemble of device instances {n} that span the device design space. The ensemble of all possible z and corresponding n, given (λ, θ) as inputs, are denoted as {z} and {n|λ, θ}, respectively.

An important feature of neural networks in accordance with a number of embodiments of the invention is the ability to incorporate layers of neurons at the output of a network. Layers in accordance with some embodiments of the invention can perform mathematical operations on the output device. In some embodiments, the last layer of the generator is a Gaussian filter, which eliminates small, pixel-level features that are impractical to fabricate. Output neuron layers in accordance with a variety of embodiments of the invention can include (but are not limited to) Gaussian filters, binarization filters, etc. The only constraint with these mathematical operations is that they need to be differentiable, so that they support backpropagation during network training.

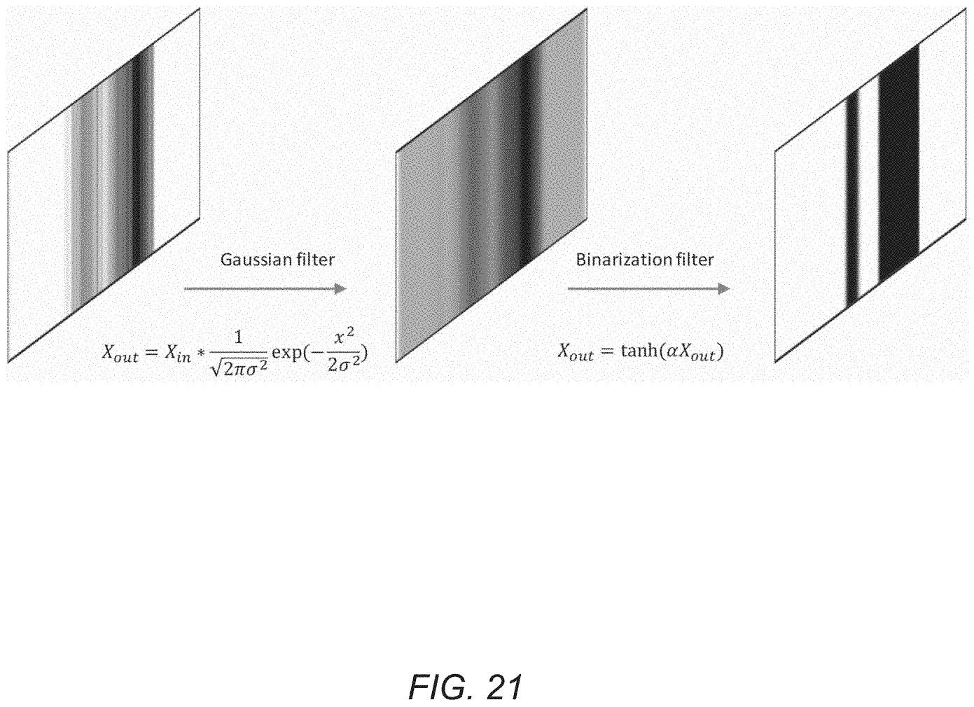

In numerous embodiments, optimization networks can include differentiable filters or operators for specific purposes. Optimization networks in accordance with several embodiments of the invention can use a Gaussian filter to remove small features, which performs convolution between input images and a Gaussian kernel. In several embodiments, optimization networks can use binarization functions (e.g., a tanh function) to binarize the images. Gradients of the loss function are able to backpropagate through those filters to neurons, so that the generated images are improved within the constraint of those filters. Filters and operators in accordance with a number of embodiments of the invention can include (but are not limited to) Fourier transform, Butterworth filter, Elliptic filter, Chebyshev filter, Elastic deformation, Projective transformation, etc. Examples of the effects of filter layers in accordance with a variety of embodiments of the invention are illustrated in FIG. 21.

In several embodiments, proper network initialization is used to ensure that a network at the start of training maps noise vectors {z} to the full design space. Processes in accordance with a number of embodiments of the invention can take randomly assign the weights in the network with small values (e.g., using Xavier initialization), which sets the outputs of the last deconvolution layer to be close to 0. In certain embodiments, processes can directly add the noise vector z to the output of the last deconvolution layer using an “identity shortcut.” In some such embodiments, the dimensionality of z is matched with n. In a number of embodiments, by combining the random assignments and using the identity shortcut, the initial ensemble of all possible generated device instances {n|λ, θ} can have approximately the same distribution as the ensemble of noise vectors {z}, and it therefore spans the full device design space.

During network training, the goal in accordance with certain embodiments of the invention is to iteratively optimize the weights w to maximize the objective function L=E̅f̅f̅, where E̅f̅f̅ is the average efficiency of the ensemble {n}. In various embodiments, to improve w each iteration, a batch of M devices, {n^{(m)}}ₘ₌₁^{M}, can be initially generated by sampling z from the noise vector distribution, λ from the target wavelength range, and θ from the target outgoing angle range. In some embodiments, random λ and θ values can be initially generated. A loss function in accordance with numerous embodiments of the invention can be described as:

$$L = - \frac{1}{M} {\sum }_{m = 1}^{M} exp ( \frac{{Eff}^{( m )} - {Eff}_{max} ( {λ}^{( m )} , {θ}^{( m )} )}{σ} ) {n}^{( m )} \cdot {g}^{( m )} \qquad ( 12 )$$

The term Effₘₐₓ(λ^{(m)}, θ^{(m)}) is the theoretical maximum efficiency for each wavelength and angle pair. In practice, Effₘₐₓ(λ^{(m)}, θ^{(m)}) is unknown, as it represents the efficiencies of the globally optimal devices. In several embodiments, over the course of network training, Effₘₐₓ(λ^{(m)}, θ^{(m)})) can be estimated to be the highest cumulative efficiency calculated from the batches of generated devices. Eff^{(m)} is the efficiency of the m^{th} device and can be directly calculated (e.g., with forward electromagnetic simulation). The expression

$$exp ( \frac{{Eff}^{( m )} - {Eff}_{max} ( {λ}^{( m )} , {θ}^{( m )} )}{σ} )$$

represents a bias term that preferentially weighs higher efficiency devices during network training and reduces the impact of low efficiency devices that are potentially trapped in undesirable local optima. In a variety of embodiments, the magnitude of this efficiency biasing term can be tuned with the hyperparameter σ.

In numerous embodiments, the gradient of the loss function with respect to the indices, for the m^{th} device, is

$$\frac{\partial L}{\partial {n}^{( m )}} = - \frac{1}{M} exp ( \frac{{Eff}^{( m )} - {Eff}_{max} ( {λ}^{( m )} , {θ}^{( m )} )}{σ} ) {g}^{( m )} .$$

In this form, minimizing the loss function L is equivalent to maximizing the device efficiencies in each batch. To train the network and update w in accordance with some embodiments of the invention, backpropagation can be used to calculate

$$\frac{\partial L}{\partial w} = \frac{1}{M} {\sum }_{m = 1}^{M} \frac{\partial L}{\partial {n}^{( m )}} \cdot \frac{\partial {n}^{( m )}}{\partial w}$$

each iteration.

To ensure that the generated devices are binary, a regularization term in accordance with certain embodiments of the invention can be added to the loss function. Regularization terms in accordance with some embodiments of the invention can be −|n^{(m)}|·(2−|n^{(m)}|). This term reaches a minimum when |n^{(m)}|=1 and the device segments are either silicon or air. Binarization conditions in accordance with many embodiments of the invention can serve as a design constraint that limits metagrating efficiency, as the efficiency enhancement term (Equation 12) favors grayscale patterns. To balance binarization with efficiency enhancement in the loss function, processes in accordance with many embodiments of the invention can include a tunable hyperparameter β. The final expression for the loss function in accordance with certain embodiments of the invention is:

$$L = - \frac{1}{M} {\sum }_{m = 1}^{M} exp ( \frac{{Eff}^{( m )} - {Eff}_{max} ( {λ}^{( m )} , {θ}^{( m )} )}{σ} ) {n}^{( m )} \cdot {g}^{( m )} + β \vert {n}^{( m )} \vert \cdot ( 2 - \vert {n}^{( m )} \vert ) \qquad ( 13 )$$

In many embodiments, the gradients of efficiency with respect to n, which specify how the device indices can be modified to improve the objective function, can be calculated for each device. For the i^{th} segment of the m^{th} device, which has the refractive index nᵢ^{(m)}, this gradient normalized to M is defined as

$$\frac{1}{M} {g}_{i}^{( m )} .$$

To ensure that the gradient for backpropagation for each device has this form, the objective function can be defined to be:

$$L = \frac{1}{M} {\sum }_{m = 1}^{M} {\sum }_{i = 1}^{256} {n}_{i}^{( m )} \cdot {g}_{i}^{( m )} \qquad ( 14 )$$

The gradient of this objective function with respect to the index, at the i^{th} output neuron for the m^{th} device, is

$$\frac{\partial L}{\partial {n}_{i}^{( m )}} = \frac{1}{M} {g}_{i}^{( m )} ,$$

matching the desired expression. To calculate the gradients applied to w each iteration, the efficiency gradients can be backpropagated for each of the M devices and the subsequent gradients can be averaged on w.

In various embodiments, efficiency gradients can be calculated using the adjoint variables method, which is used in adjoint-based topology optimization. These gradients are calculated from electric and magnetic field values taken from forward and adjoint electromagnetic simulations. In a number of embodiments, neural networks, in which the non-linear mapping between (λ, θ) and device layout are iteratively improved using physics-driven gradients, can be viewed as a reframing of the adjoint-based optimization process. Unlike other manifestations of machine learning-enabled photonics design, approaches in accordance with various embodiments of the invention do not use or require a training set of known devices but instead can learn the physical relationship between device geometry and response directly through electromagnetic simulations.

Although many of the examples herein are described with reference to efficiency gradients, one skilled in the art will recognize that similar performance gradients can be used in a variety of applications, including (but not limited to) other types of efficiency gradients and/or other types of performance gradients, without departing from this invention. Performance gradients in accordance with a variety of embodiments of the invention can include heat conductivity in a thermal conductor used as a heat sink, generated power in a thermoelectric, speed and power in an integrated circuit, and/or power generated in a solar collection device. In the case of aperiodic broadband devices, an efficiency gradient can include the weighted summation of efficiency gradients at different wavelengths.

### Network Architecture

In examples described herein, the architecture of the generative neural network is adapted from DCGAN, which comprises 2 fully connected layers, 4 transposed convolution layers, and a Gaussian filter at the end to eliminate small features. One skilled in the art will recognize that similar systems and methods can be used in a variety of applications, without departing from this invention. Activation functions of examples described herein use LeakyReLU for activation, except for the last layer, which uses a tanh, but one skilled in the art will recognize that various activation functions can be used in a variety of applications, without departing from this invention. Architectures in accordance with some embodiments of the invention can include dropout layers and/or batchnorm layers to enhance the diversity of the generated patterns. In a number of embodiments, periodic paddings can be used to account for the fact that the devices are periodic structures.

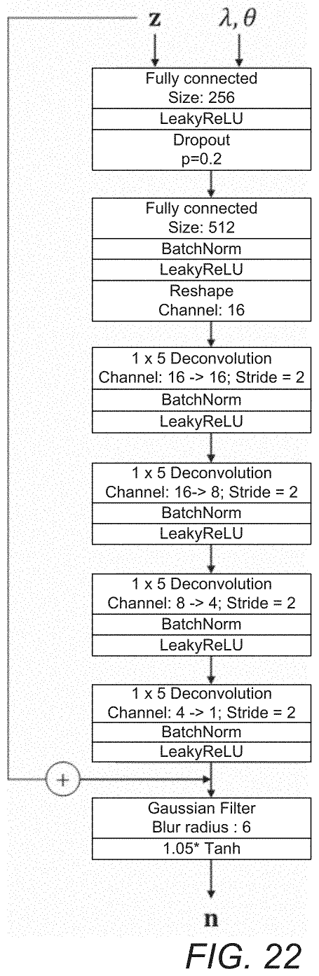

An example network architecture of a conditional global optimization network in accordance with an embodiment of the invention is illustrated in FIG. 22. In this example, the input to the generator is a 1×256 vector of uniformly distributed variables, the operating wavelength, and the output deflection angle. All of these variables can be normalized to numbers between −1 and 1. The output of the generator is a 1×256 vector. A Gaussian filter is added at the end of the generator, before the tanh layer, to eliminate extra-fine spatial features in the generated devices.

During the training process in accordance with a number of embodiments of the invention, generators can use the Adam optimizer with a batch size of 1250, learning rate of 0.001, of 0.9, β₂ of 0.99, and σ of 0.6. In a variety of embodiments, conditional global optimization networks can be trained for a number of iterations (e.g., 1000). β is 0 for a first portion (e.g., 500) of the iterations and is increased (e.g., 0.2) for the remaining iterations. In certain embodiments, can be updated multiple times during training.

### Training Procedures

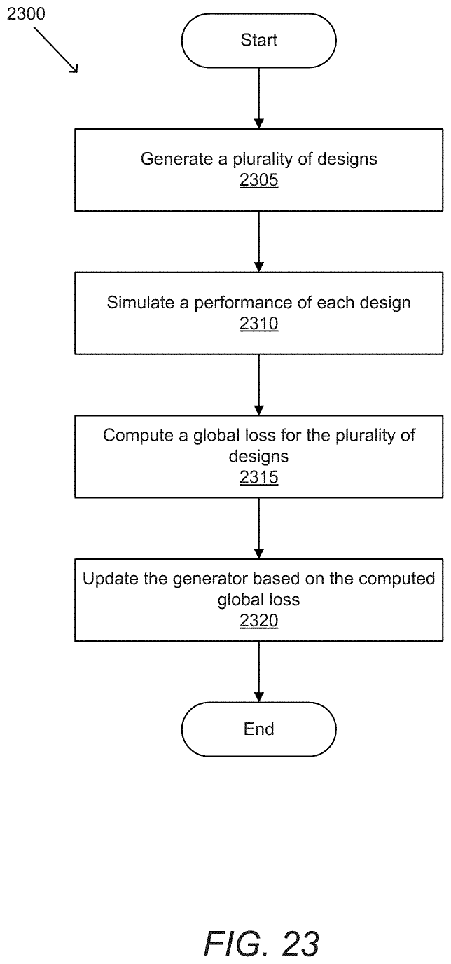

A process for training a global optimization network is illustrated in FIG. 23. In several embodiments, training processes can be performed for a number of iterations to train the generator. During the training process, P_{ϕ} is continuously refined and shifted towards the high-efficiency device subspace. When generators are trained in accordance with many embodiments of the invention, designs produced from the generators have a high probability to be highly efficient.

Process 2300 generates (2305) a plurality of designs. Designs in accordance with some embodiments of the invention can be any of a number of different types of designs that can be simulated by a physics-based engine. In many embodiments, in order to generate the designs, the generator is provided with inputs to direct the generation. Inputs in accordance with numerous embodiments of the invention can include, but are not limited to, random noise vectors and target design parameters (e.g., target wavelength). In a variety of embodiments, random noise vectors are sampled from a latent space. In order to fully sample the space [symbol] in the early stage of training, batch sizes in accordance with certain embodiments of the invention can initially be relatively large and then gradually reduce to a small number when design samples start to cluster. a should be a relatively large number ˜10-40 for Xavier initialization. By conditioning global optimization networks with a continuum of operating parameters, ensembles of devices can be simultaneously optimized, further reducing overall computation cost.

Process 2300 simulates (2310) a performance of each design. Simulations in accordance with many embodiments of the invention can be used to determine various characteristics of each generated design. In various embodiments, simulations are performed using an electromagnetics solver that can perform forward and adjoint simulations. Simulations in accordance with a variety of embodiments of the invention can be performed in parallel across multiple processors and/or machines in existing cloud and/or server computing infrastructures.

Process 2300 computes (2315) a global loss for the plurality of designs. In some embodiments, global losses allow each candidate design to contribute to the global loss that will be backpropagated through the generator. Global losses in accordance with a number of embodiments of the invention can be weighted based on a performance metric (e.g., efficiency) to bias the generator to generate high-performance designs.

Process 2300 updates (2320) the generator based on the computed global loss. In several embodiments, updating the generator comprises backpropagating the global loss through the generator.

In a variety of embodiments, once a generator has been trained, it can be used to generate candidate designs, where a number of the candidate designs are selected for further processing, such as (but not limited to) optimization, fabrication, implementation, etc. In certain embodiments, the number is a pre-selected number (e.g., 1, 5, etc.). Alternatively, or conjunctively, all elements with characteristics exceeding a threshold value (e.g., an efficiency value) are selected. By taking the best device from the optimized device batch { [symbol] b{x}\hat{ }{(m)}|x^{(m)}˜P_{ϕ*}}ₘ₌₁^{M}, there is a possibility for the optimizer to get to the global optimum.

### Results

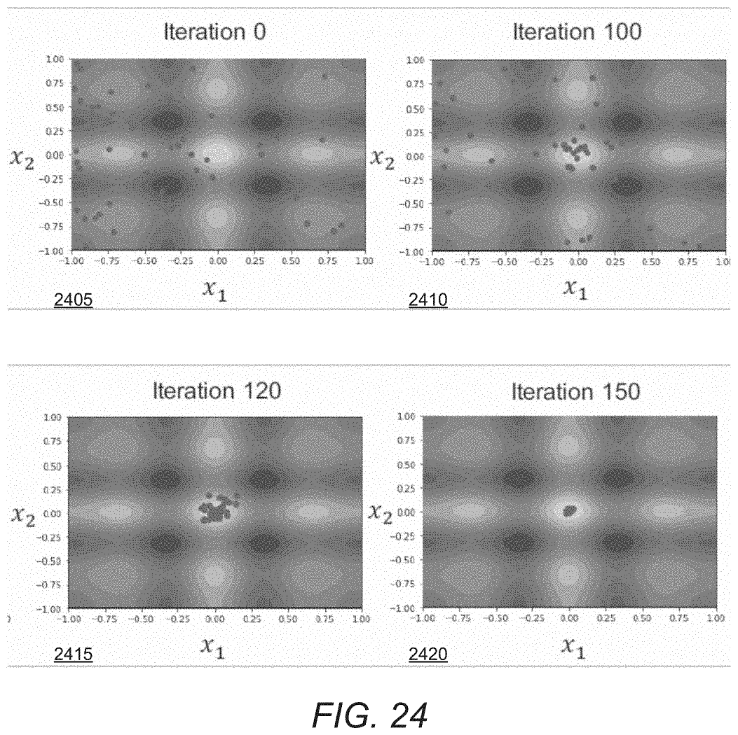

Results of global optimization processes in accordance with a number of embodiments of the invention using a simple testing case are illustrated in FIG. 24. In this testing case, the dimensions of the input z and output x are 2, and the efficiency function Eff(x) is defined as:

Eff(x₁,x₂)=exp(−2x₁²)cos(9x₁)+exp(−2x₂²)cos(9x₂) (15)

which is a non-convex function with plenty of local optima and one global optimum at (0, 0). Algorithm 1 is used to search for the global optimum, with hyperparameters α=1e−3, β₁=0.9, β₂=0.999, α=30, and σ=0.5, and the batch size M=100 is constant. The generator is trained for 150 iterations and the generated samples over the course of training are shown as red dots in stages 2405-2420. Initially, the samples spread out over the x space, then gradually converge to a cluster located at the global optimum. No samples are trapped in local optima. This experiment was repeated 100 times, and 96 of them successfully found the global optimum.

In another example, processes in accordance with several embodiments of the invention are applied to the inverse design of 63 different types of metagratings, each with differing operating wavelengths and deflection angles. The wavelengths λ range from 800 nm to 1200 nm, in increments of 50 nm, and the deflection angles θ range from 40 degrees to 70 degrees, in increments of 5 degrees.

Processes in accordance with numerous embodiments of the invention are compared with brute-force topology optimization. For each design target (λ, θ), 500 random gray-scale vectors are each iteratively optimized using efficiency gradients with respect to device patterns. Efficiency gradients are calculated from forward simulation and backward simulation. In this example, a threshold filter is used to binarize the device patterns. Each starting point is also optimized for 200 iterations, and the highest efficiency device among 500 candidates is taken as final design.

In many inverse design approaches, brute-force searching with local optimizers is used to find out the global optimum. With brute-force searching, a large number of device patterns are randomly initialized and then optimized individually using gradient descent. The highest efficiency device among those optimized devices is taken as the final design. With this approach, many devices usually get trapped in local optima in [symbol] . Additionally, finding the global optimum in a very high dimensional space is more challenging with this method.

In several embodiments, a distribution of devices can be collectively optimized. As indicated in Equation 11, higher efficiency devices bias the generator more than low-efficiency devices, which can be helpful to avoid low-efficiency local optima. The device distribution dynamically changes during the training process, and over the course of optimization, more calculations are performed to explore more promising parts of the design space and away from low-efficiency local optima.

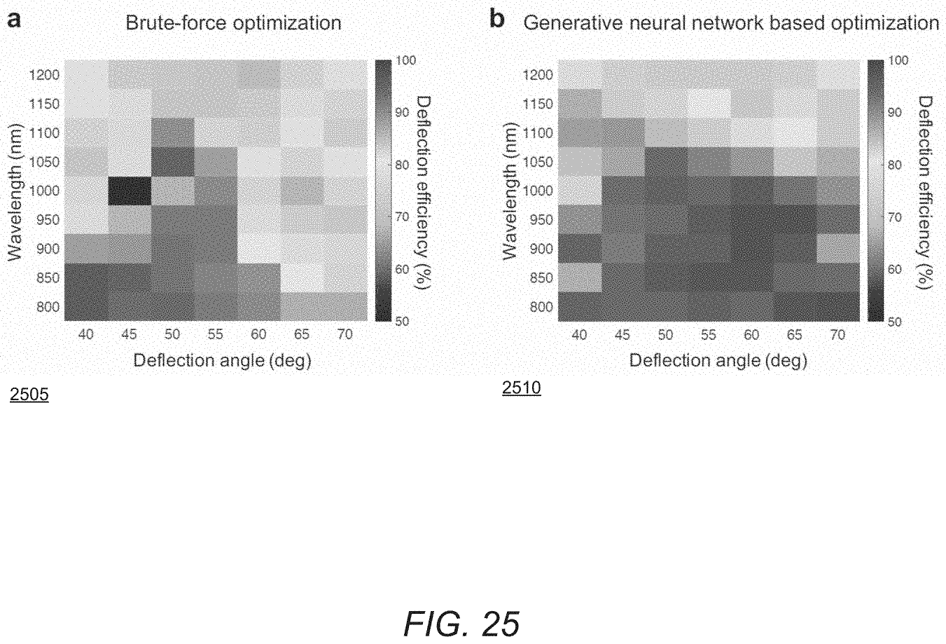

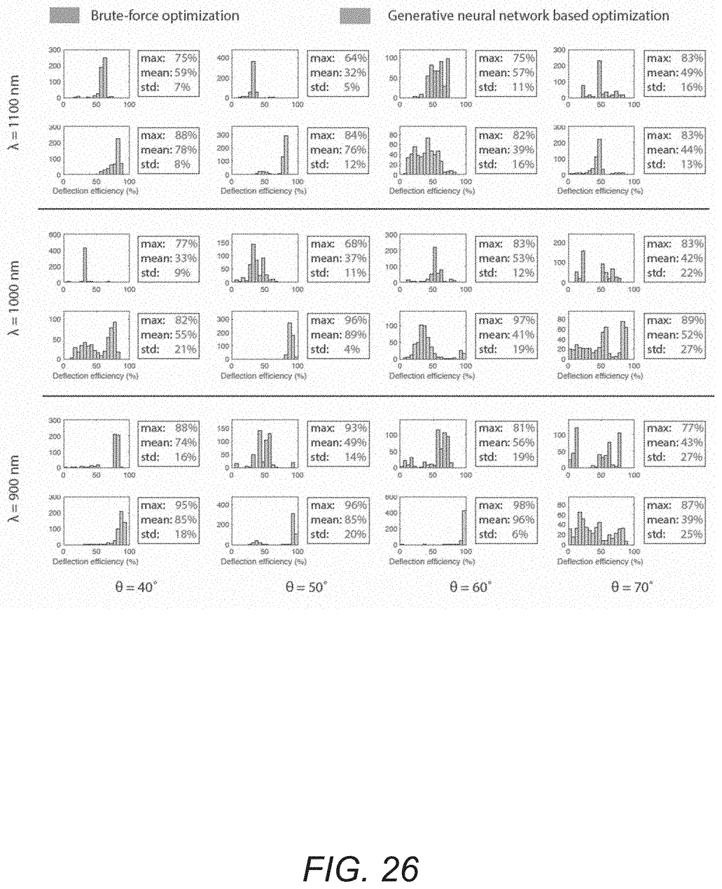

Comparative results of brute-force strategies and global optimization processes in accordance with numerous embodiments of the invention are illustrated in FIGS. 25 and 26. The efficiencies for devices designed using brute-force optimization and processes in accordance with many embodiments of the invention are shown in FIG. 25. This figure includes plots of efficiency for devices operating with different wavelength and angle values. The first chart 2505 illustrates a plot of efficiency for devices designed using brute-force topology optimization. The second chart 2510 illustrates a plot of efficiency for devices designed using generative neural network-based optimization. For each wavelength and angle combination, 500 individual topology optimizations are performed and the highest efficiency device is used for the plot. 86\% of devices from generative neural network based optimization have higher efficiency than those from brute-force optimization, and on average are 7.2\% higher.

Efficiency histograms, for select wavelength and angle pairs, of devices designed using brute-force topology optimization (top row) and generative neural network-based optimization (bottom row) are illustrated in FIG. 26. The statistics of device efficiencies in each histogram are also displayed. For most cases, efficiency histograms produced using processes in accordance with various embodiments of the invention are narrower, have higher average efficiencies and maximal efficiencies, indicating that low-efficiency local optima are often avoided during the training of the generator.

In this example, the hyperparameters are set to α=0.05, β₁=0.9, β₂=0.99, a=40, α=0.2, and γ=0.05. The initial batch size is 500 and gradually decreases to 20. To prevent vanishing gradients when the generated patterns are binarized as x∈{−1,1}^{N}, the last activation function tanh is replaced with 1.02*tanh. For each combination of wavelength and angle, the generator is trained for 200 iterations. When the training is done, 500 device samples are produced by the generator and the highest efficiency device is taken as the final design.

Comparison with Adjoint-Based Topology Optimizer

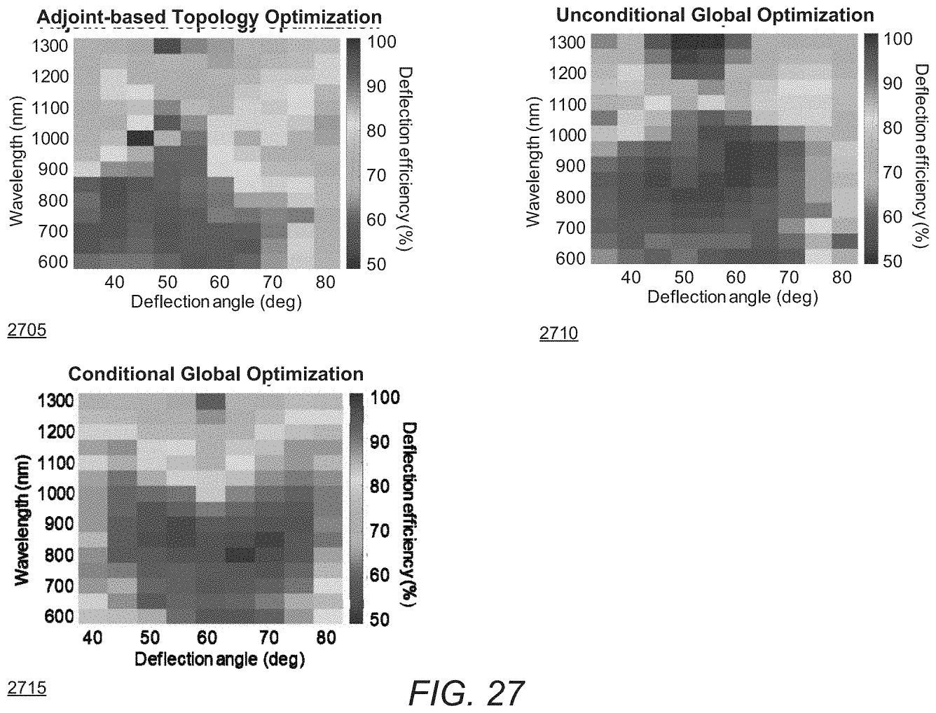

To benchmark devices designed from processes in accordance with various embodiments of the invention, results from adjoint-based topology optimization and global optimization networks (or generative design networks) is illustrated in FIG. 27. A detailed analysis indicates that conditional global optimization networks in accordance with various embodiments of the invention can use 10× less computational cost compared to adjoint-based topology optimization calculations. In this example, deflection efficiency plots 2705, 2710, and 2715 illustrate the best-performing devices for each wavelength/deflection angle combination, for adjoint-based topology optimization, unconditional global optimization, and conditional global optimization respectively. Adjoint-based topology optimization and global optimization are performed on metagratings operating across a desired range of wavelengths and angles. These devices operate across a wavelength range between 600 nm and 1300 nm, in increments of 50 nm, and across a deflection angle range between 35 degrees and 85 degrees, in increments of 5 degrees. For each wavelength and angle pair, 500 devices are optimized, each with random grayscale patterns serving as initial dielectric distributions. A total of 200 iterations is performed for each optimization, and the deflection efficiencies of the optimized devices are calculated using a rigorous coupled-wave analysis (RCWA) solver. The highest efficiency device, for each wavelength and angle pair, is plotted in plots 2705, 2710, and 2715. In this example, both the unconditional and conditional global optimization networks are able to produce high efficiency devices for a much larger range of wavelength and deflection angle combinations when compared to the adjoint-based topology optimizations.

The efficiency values of plots 2705 and 2710 indicate that the best devices from global optimization networks compare well with the best devices from adjoint-based optimization. Statically, 57% of devices from global optimization networks have efficiencies higher than those from adjoint-based optimization, and 87% of devices from global optimization have efficiencies within 5% or higher than those from adjoint-based optimization. While global optimization performs well for most wavelength and angle values, it does not optimally perform in certain regimes, such as the wavelength and angle ranges of 1200 nm to 1300 nm and 50 degrees to 60 degrees, respectively. In several embodiments, these nonidealities can be improved with further refinement of the network architecture and training process.

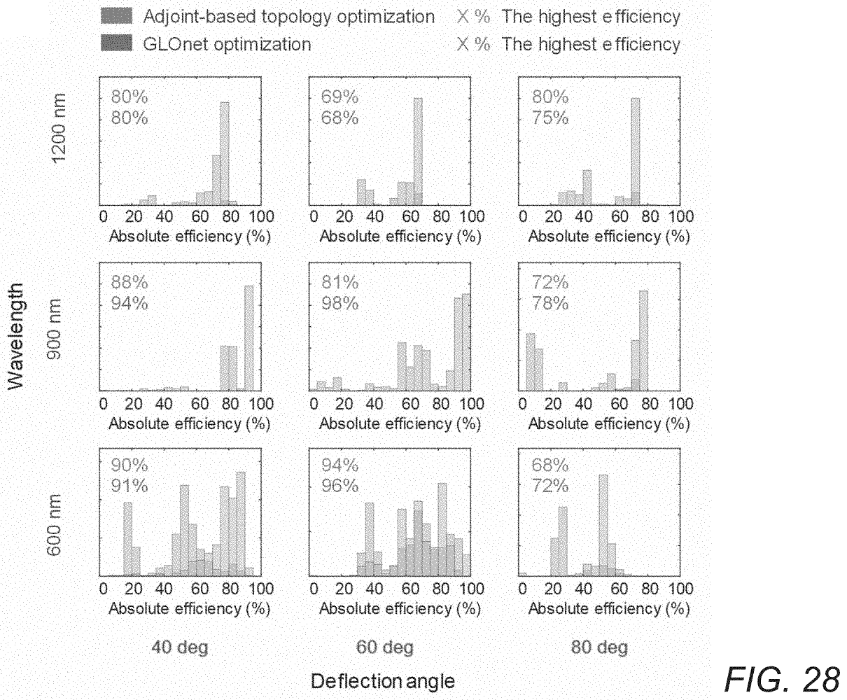

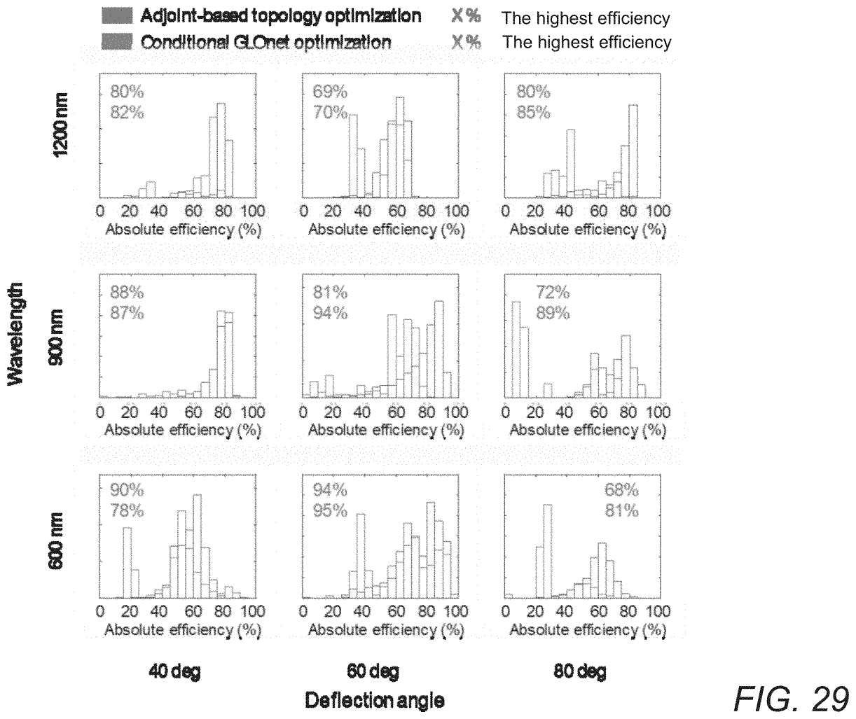

The efficiency histograms from adjoint-based topology optimization and global optimization, for select wavelength and angle pairs, are illustrated in FIGS. 28 and 29. FIG. 28 illustrates results from an unconditional global optimization network, while FIG. 29 illustrates results from a conditional global optimization network. These figures illustrate that efficiency histograms from the adjoint-based optimized devices (red) have relatively broad distributions in efficiency. This indicates that the initial dielectric distributions of these devices broadly span the design space, and with each device being locally optimized, the result is a diversity of devices supporting a range of layouts and efficiencies. The global optimization-generated devices (blue), on the other hand, tend to have more devices clustered at the high efficiency end of the distribution. This trend is consistent with the objective of global optimization, which is to optimize the average efficiency of the distribution of generated devices. Each histogram also shows the highest device efficiencies for the wavelength/angle combination. For most wavelength and angle values, the efficiency distributions from both conditional and unconditional global optimization are narrower and have higher maximum values compared to those from adjoint-based topology optimization.

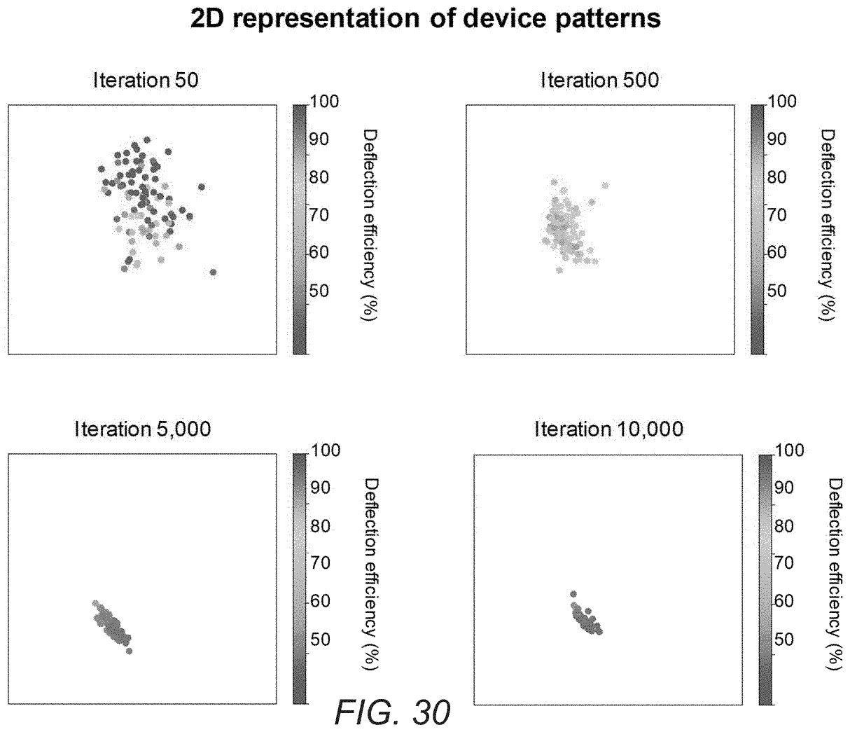

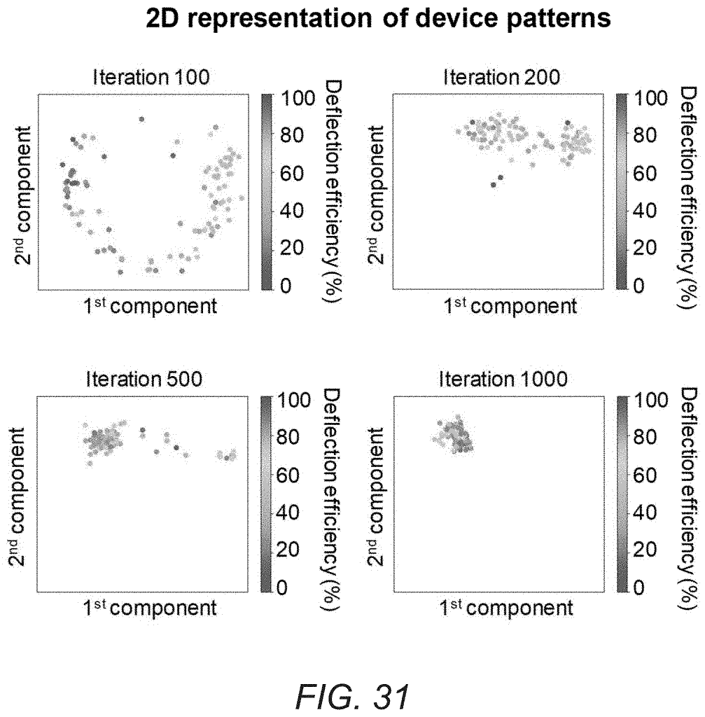

A visualization of the evolution of device patterns and efficiency histograms as a function of unconditional global optimization training is illustrated in FIG. 30. A visualization of the evolution of device patterns and efficiency histograms as a function of conditional global optimization training is illustrated in FIG. 31. FIGS. 30 and 31 illustrate visualizations of 100 device patterns generated by unconditional and conditional global optimization respectively, at different iteration numbers, depicted in a 2D representation of the design space. All devices are designed to operate at a wavelength of 900 nm and an angle of 60 degrees. Initially, at iteration 50, the distribution of generated devices is spread broadly across the design space and the efficiency histogram spans a wide range of values, with most devices exhibiting low to modest efficiencies. As network training progresses, the distribution of generated devices clusters more tightly and the efficiency histogram narrows at high efficiency values. By the 10,000 iteration mark, the generated devices have very high efficiencies and have converged to nearly the same device layout.

An examination of total computation time indicates that global optimization is computationally efficient when simultaneously optimizing a broad range of devices operating at different wavelengths and angles. In this example, the total number of simulations to train the global optimization network is 1,200,000: the network trains over 30,000 iterations, uses batch sizes of M=20 device instances per iteration, and uses a forward and adjoint simulation per device to compute its efficiency gradient. When divided by the 150 unique wavelength and angle combinations, the number of simulations per wavelength and angle pair is 8,000, which amounts to 20 adjoint-based topology optimization runs (one run has 200 iterations and 2 simulations/iteration). As a point of comparison, 500 adjoint-based topology optimization runs were required to produce the adjoint-based optimizations.

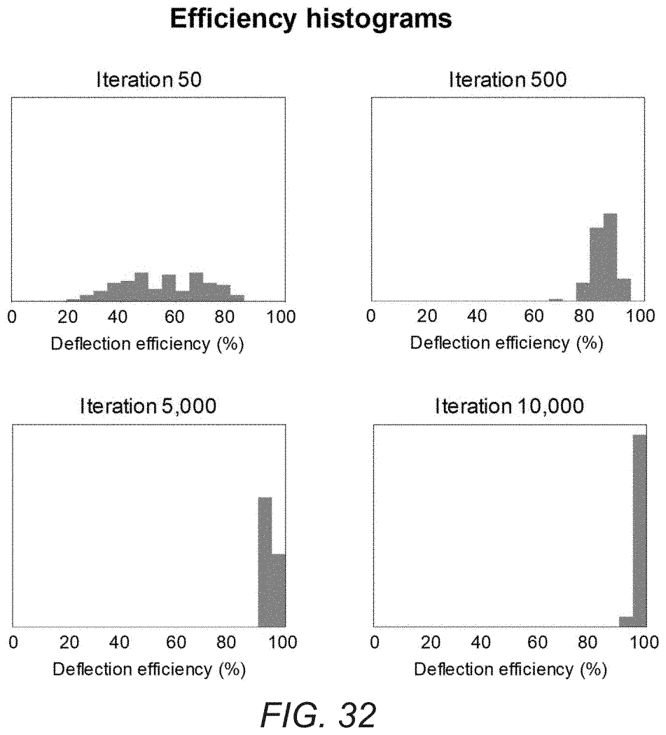

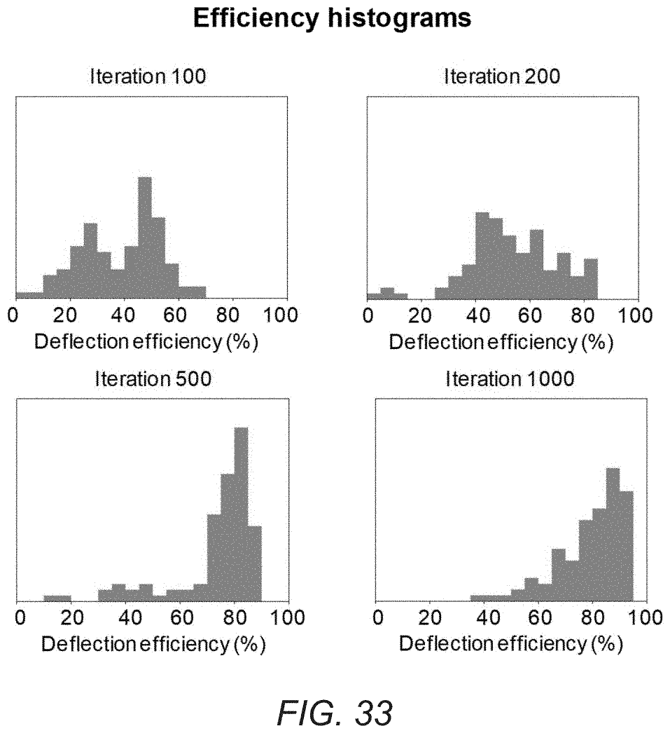

Efficiency histograms of generated devices for unconditional and conditional global optimization at various iterations are illustrated in FIGS. 32 and 33 respectively. To help visualize the process of device optimization with global optimization, the way that the distribution of devices in the design space, together with its corresponding efficiency histogram, evolves over the course of network training is shown. The devices in this example all operate at the wavelength of 900 nm and deflection angle of 60 degrees, and 100 devices are randomly generated during each iteration of training. The high dimensional design space can be visualized by performing a principle components analysis (PCA) on the binary metagratings dataset from adjoint-based optimization and then reducing the dimensionality of the space to two dimensions. In these examples, the efficiency histogram is initially broad and converges to a sharp distribution of high efficiency devices by the 10,000 iteration mark.

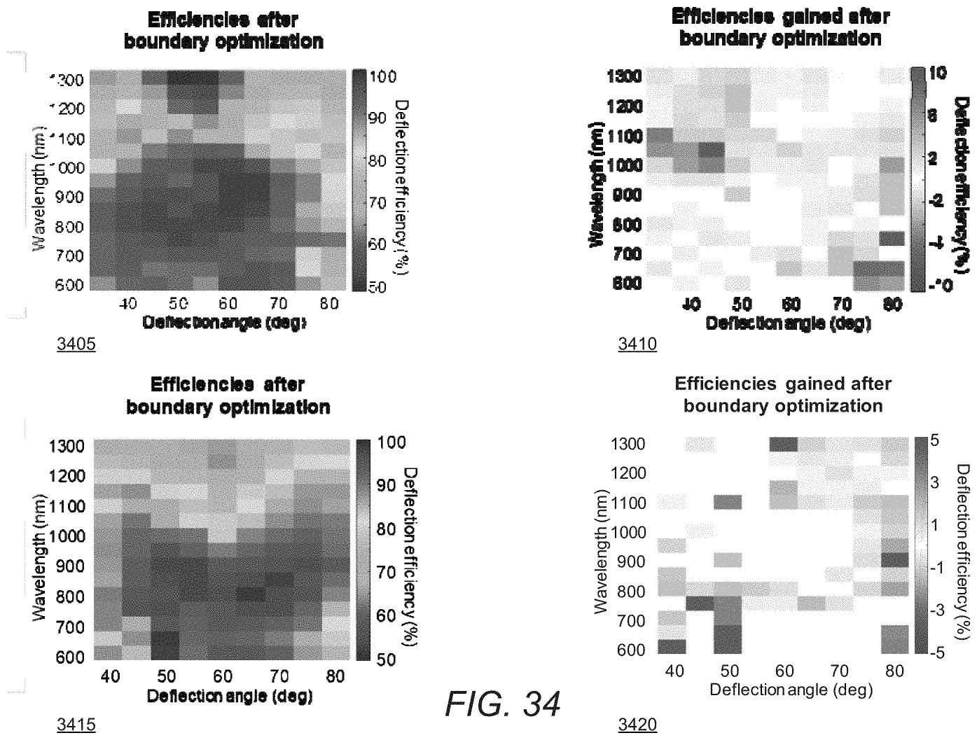

In a variety of embodiments, generated devices can be further refined using adjoint-based boundary optimization. Example results of adjoint-based boundary optimization in accordance with a number of embodiments of the invention are illustrated in FIG. 34. In adjoint-based boundary optimization, the gradient of efficiency with respect to refractive index can be calculated by conducting a forward and adjoint simulation, which is consistent with topology optimization. However, processes in accordance with numerous embodiments of the invention only consider the gradients at the silicon-air boundaries of the device and fix the device refractive indices to be binary throughout the optimization. In various embodiments, a number of iterations (e.g., five) of boundary optimization are performed on the highest efficiency generated device for each wavelength and angle pair. The final device efficiencies for devices generated with unconditional optimization after boundary optimization are shown in the first portion 3405 and the differential changes in efficiency are shown in the second portion 3410. The final device efficiencies for devices generated with conditional optimization after boundary optimization are shown in the third portion 3415 and the differential changes in efficiency are shown in the fourth portion 3420. Most of the efficiency changes are relatively modest and only a small percentage (8% and 4%) of the devices have efficiency gains larger than 5%, indicating that devices from global optimization networks are already at or near local optima.

In several embodiments, instead of optimizing many devices individually, global optimization for non-convex problems can be reframed as the training of a generator to generate high performing devices with high probability. Efficiency gradients of multiple device samples can collectively improve the performance of the generator, which is helpful to explore the whole device space [symbol] and avoid low-efficiency local optima. Systems and methods in accordance with numerous embodiments of the invention can be applied to other complex systems, such as (but not limited to) 2D or 3D metasurfaces, multi-function metasurfaces, and other photonics design problems. Multi-function metasurfaces design can require optimizing multi-objectives simultaneously.

Certain issues can arise in the generative design of higher-dimension metasurfaces. First, upon scaling, the design space becomes exponentially larger, making a search through this space highly computationally expensive and potentially intractable. Consider, as an example, a two layer metasurface, where each layer is 128 by 256 pixels: the total number of possible device configurations is 2^{65,536}, which is an immense number. The global optimization problem amounts to searching for a needle in a haystack the size of many universes. Systems and methods in accordance with various embodiments of the invention can initially train a global optimization network on a problem with much coarser spatial resolution, which is a much more tractable problem in a lower dimension design space. The spatial resolution of the network can then be progressively increased, through the addition of deconvolution layers at the output of the global optimization network, and the network can be retrained after each addition. In the example of a two layer metasurface, each device layer can be specified to have a spatial resolution of 8 by 16 pixels. The total number of possible device configurations is 2²⁵⁶, which is tractable and similar to the 1D metagrating device space described above. The resolution can then be increased (e.g., to 16 by 32 pixels, 32 by 64 pixels, 64 by 128 pixels, and then 128 by 256 pixels).

Progressive growth optimization networks in accordance with numerous embodiments of the invention assume that the design space for high quality, low spatial resolution devices puts the search in some proximity of the desired region of the overall design space. As spatial resolution increases and the dimensionality of the design space increases, global optimization networks can function more as a local optimizer at these more limited regions of the design space. In many embodiments, a low resolution optimization is performed with a global optimization network. High-performing designs are selected, and a higher-resolution optimization is performed in the “space” of the high-performing designs. As such, instead of searching for a needle in a giant haystack, the process can first start with a smaller haystack that has the main qualitative features of the giant haystack, find a low resolution needle, grow the haystack, and repeat. In a variety of embodiments, the distribution of generated designs is tuned to be broader or narrower at different levels of the search. For example, processes in accordance with various embodiments of the invention can generate narrow distributions early in the training process, with increasingly broader distributions as the process continues.

Figuring out network architectures and hyperparameters for a specific design problem can be difficult. Typically, these parameters are manually hand-tuned by a data scientist, and the methodology employed involves a combination of experience, intuition, and heuristics. In many cases, the network parameters to depend strongly on the specific problem of interest, meaning that they will need to be constantly modified as the design problem changes. Also, there are many candidate architectures and hyperparameters to draw from, making it unclear what to try. In addition, global optimization networks are an entirely new type of neural network concept for which there is no preexisting experience and intuition.

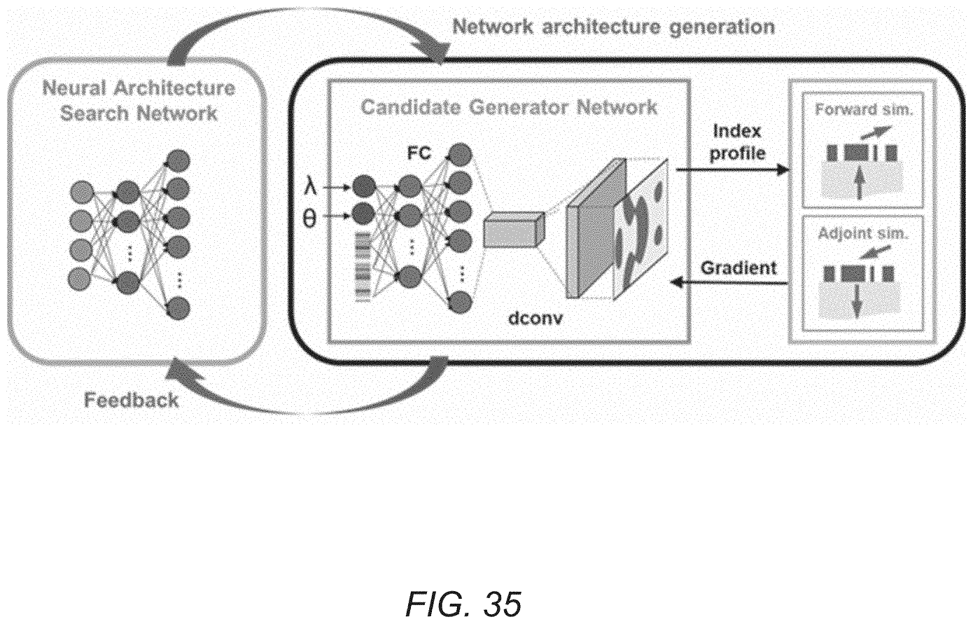

Systems and methods in accordance with several embodiments of the invention can utilize concepts in meta-learning to discover and refine network architectures and hyperparameters suitable for global optimization systems. An example of a meta-learning system is illustrated in FIG. 35. With meta-learning, a separate, fully connected architecture search neural network can be created with the task of outputting candidate architecture and hyperparameter values. Architecture search networks in accordance with numerous embodiments of the invention can learn by applying different combinations of these values to different manifestations of global optimization networks (e.g., conditional, progressive growth, etc.), evaluating those global optimization networks with clear quantitative metrics, and using these metrics as feedback for network backpropagation. This can provide a systematic and even automated way to figure out what parameters are best suited for network optimization and how these parameters can be modified as the scope of the design problem changes. Network architecture concepts and hyperparameters for meta-learning can include (but are not limited to) the learning rate, batch size, sampling plan for each batch, number of fully connected layers, and the hyperparameter σ, which is a noise term in the global optimization loss function that helps to specify the diversity of devices. Global optimization networks in accordance with numerous embodiments of the invention can function most optimally when the batch size and a are adjusted over the course of network training, as the network shifts from a global search tool to a local optimizer, adding to the complexity and necessity of meta-learning.

Approaches in accordance with a number of embodiments of the invention can provide an effective and computationally-efficient global topology optimizer for metagratings. In some embodiments, a global search through the design space is possible because the generative neural network can optimize the efficiencies of device distributions that initially span the design space. The best devices generated by global optimization compare well with the best devices generated by adjoint-based topology optimization. Although specific examples of generative design networks or global optimization networks are described herein, one skilled in the art will recognize that networks with various parameters, such as (but not limited to) network architecture, input noise characteristics, and training parameters, can be used as appropriate to a variety of applications, without departing from this invention. Adjustment of parameters in accordance with some embodiments of the invention can lead to higher performance and more robustness to stochastic variations in training. Systems and methods in accordance with many embodiments of the invention can be applied to various other metasurface systems, including (but not limited to) aperiodic, broadband devices. In various embodiments, systems and methods can apply to the design of other classes of photonic devices and more broadly to other physical systems in which device performance can be improved by gradient descent.

While specific processes for global optimization are described above, any of a variety of processes can be utilized for global optimization as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to metasurface design, the techniques disclosed herein may be used in any of several types of gradient-based generative processes, including (but not limited to) optics design, and/or optimizations of acoustic, mechanical, thermal, electronic, and geological systems.

Although the present invention has been described in certain specific aspects, many additional modifications and variations would be apparent to those skilled in the art. It is therefore to be understood that the present invention may be practiced otherwise than specifically described, including any variety of models of and machine learning techniques to train and generate metagratings, without departing from the scope and spirit of the present invention. Thus, embodiments of the present invention should be considered in all respects as illustrative and not restrictive.

What is claimed is:

1. A method for training a generator to generate designs, the method comprising:
generating a plurality of candidate designs using a generator;
evaluating a performance of each candidate design of the plurality of candidate designs;
computing a global loss for the plurality of candidate designs based on the evaluated performances; and
updating the generator based on the computed global loss.

2. The method of claim 1 further comprising receiving an input element of features representing the plurality of candidate designs, wherein the input element comprises a random noise vector.

3. The method of claim 1, wherein:
the input element further comprises a set of one or more target parameters, and
the set of target parameters comprises at least one of a wavelength, a deflection angle, device thickness, device dielectric, polarization, phase response, and incidence angle.

4. The method of claim 1, wherein evaluating the performance comprises performing a simulation of each candidate design.

5. The method of claim 4, wherein the simulation is performed using a physics-based engine.

6. The method of claim 1, wherein computing the global loss comprises weighting a gradient for each candidate design based on a value of a performance metric for the candidate design.

7. The method of claim 6, wherein the performance metric is efficiency.

8. The method of claim 1, wherein computing the global loss comprises:
computing forward electromagnetic simulations of the plurality of candidate designs;
computing adjoint electromagnetic simulations of the plurality of candidate designs; and
computing an efficiency gradient with respect to refractive indices for each candidate design by integrating the overlap of the forward electromagnetic simulations and the adjoint electromagnetic simulations.

9. The method of claim 1, wherein the global loss comprises a regularization term to ensure binarization of the generated patterns.

10. The method of claim 1, wherein the generator comprises a set of one or more differentiable filter layers.

11. The method of claim 10, wherein the set of differentiable filter layers comprises at least one of a Gaussian filter layer and a set of one or more binarization layers to ensure binarization of the generated patterns.

12. The method of claim 1 further comprising:
receiving a second input element that represents a second plurality of candidate designs;
generating the second plurality of candidate designs using the generator, wherein the generator is trained to generate high-efficiency designs;
evaluating each candidate design of the second plurality of candidate designs based on simulated performance of each of the second plurality of candidate designs; and
selecting a set of one or more highest-performing candidate designs from the second plurality of candidate designs based on the evaluation.

13. The method of claim 1, wherein each design of the plurality of candidate designs is a metasurface.

14. A non-transitory machine readable medium containing processor instructions for training a generator to generate designs, where execution of the instructions by a processor causes the processor to perform a process that comprises:
generating a plurality of candidate designs using a generator;
evaluating a performance of each candidate design of the plurality of candidate designs;
computing a global loss for the plurality of candidate designs based on the evaluated performances; and
updating the generator based on the computed global loss.

15. The non-transitory machine readable medium of claim 14, wherein the process further comprises receiving an input element of features representing the plurality of candidate designs, wherein the input element comprises a random noise vector and a set of one or more target parameters, wherein the set of target parameters comprises at least one of a wavelength, a deflection angle, device thickness, device dielectric, polarization, phase response, and incidence angle.

16. The non-transitory machine readable medium of claim 14, wherein evaluating the performance comprises performing a simulation of each candidate design using a physics-based engine.

17. The non-transitory machine readable medium of claim 14, wherein computing the global loss comprises weighting a gradient for each candidate design based on a value of a performance metric for the candidate design.

18. The non-transitory machine readable medium of claim 14, wherein computing the global loss comprises:
computing forward electromagnetic simulations of the plurality of candidate designs;
computing adjoint electromagnetic simulations of the plurality of candidate designs; and
computing an efficiency gradient with respect to refractive indices for each candidate design by integrating the overlap of the forward electromagnetic simulations and the adjoint electromagnetic simulations.

19. The non-transitory machine readable medium of claim 14, wherein the generator comprises a set of one or more differentiable filter layers comprising at least one of a Gaussian filter layer and a set of one or more binarization layers to ensure binarization of the generated patterns.

20. The non-transitory machine readable medium of claim 14, wherein the generator comprises a set of one or more differentiable filter layers, wherein the differentiable filter layers comprise at least one of a Gaussian filter layer and a set of one or more binarization layers to ensure binarization of the generated patterns.
